(19) United States
(12) Patent Application Publication
(10) Pub. No.: US 2025/0257609 A1
(43) Pub. Date: Aug. 14, 2025

(54) METHOD FOR IMPROVED AESTHETICS OF DYNAMIC GLASS

(71) Applicant: View Operating Corporation, San Jose, CA (US)

(72) Inventors: Illayathambi Kunadian, San Jose, CA (US); Sridhar Karthik Kailasam, Fremont, CA (US); Imran Ali Khan, Milpitas, CA (US); Anshu Ajit Pradhan, Collierville, TN (US); Eithan Ritz, Memphis, TN (US)

(73) Assignee: View Operating Corporation, San Jose, CA (US)

(21) Appl. No.: 18/879,034

(22) PCT Filed: Jun. 29, 2023
(86) PCT No.: PCT/US2023/026578

§ 371 Date: Dec. 26, 2024

Related U.S. Application Data
(60) Provisional application No. 63/356,758, filed on Jun. 29, 2022.

(51) Int. Cl. E06B 9/24; G02F 1/163

(52) U.S. Cl. CPC E06B 9/24; G02F 1/163; E06B 2009/2464

(57) ABSTRACT

Methods, computer program products, and devices for controlling tint of electrochromic devices that includes, e.g., applying ramp-to-drive voltage having magnitude that increases during ramp-to-drive period, applying drive voltage having substantially constant magnitude and same polarity as ramp-to-drive voltage at end of ramp-to-drive period, applying drive-reverse voltage, and applying hold voltage having same polarity as, and smaller magnitude than, drive voltage.

### CROSS-REFERENCES TO RELATED APPLICATIONS

A PCT Request Form is filed concurrently with this specification as part of the present application. Each application that the present application claims benefit of or priority to as identified in the concurrently filed PCT Request Form is incorporated by reference herein in its entirety and for all purposes.

### BACKGROUND

Electrochromism is a phenomenon in which a material exhibits a reversible electrochemically-mediated change in an optical property when placed in a different electronic state, typically by being subjected to a voltage change. The optical property is typically one or more of color, transmittance, absorbance, and reflectance. One well known electrochromic material is tungsten oxide (WO₃). Tungsten oxide is a cathodic electrochromic material in which a coloration transition, transparent to blue, occurs by electrochemical reduction.

Electrochromic materials may be incorporated into, for example, windows for residential, commercial, and other uses. The color, transmittance, absorbance, and/or reflectance of such windows may be changed by changing a feature of the electrochromic material, that is, electrochromic windows are windows that can be darkened or lightened electronically. A small voltage applied to an electrochromic device of the window will cause them to darken; reversing the voltage causes them to lighten. This capability allows control of the amount of light that passes through the windows, and presents an opportunity for electrochromic windows to be used as energy-saving devices.

While electrochromism was discovered in the 1960s, electrochromic devices, and particularly electrochromic windows, still unfortunately suffer various problems and have not begun to realized their full commercial potential despite many recent advances in electrochromic technology, apparatus and related methods of making and/or using electrochromic devices.

### SUMMARY

In some embodiments, methods are provided for controlling tint transition of electrochromic devices and optically switchable windows.

One aspect of the disclosure provides methods for controlling optical states of electrochromic devices. In some implementations, the method includes: applying a ramp-to-drive voltage to the electrochromic device in a ramp-to-drive period, wherein the ramp-to-drive voltage has a magnitude that increases in the ramp-to-drive period; applying, after the ramp-to-drive period, a drive voltage to the electrochromic device in a drive period, wherein the drive voltage has a substantially constant magnitude and a polarity that is the same as a polarity of the of the ramp-to-drive voltage at the end of the ramp-to-drive period; applying, after the drive period, a drive-reverse voltage to the electrochromic device in a drive-reverse period, wherein the drive-reverse voltage has a polarity that is opposite from the polarity of the drive voltage; and applying, after the drive-reverse period, a hold voltage to the electrochromic device in a hold period, wherein the hold voltage has a polarity that is the same as the polarity of the drive voltage and has a magnitude smaller than the magnitude of the drive voltage.

Another aspect of the disclosure provides an apparatus including a controller. The controller includes a processor and memory. The controller is configured to control optical states of an electrochromic device by performing any one of the methods disclosed herein.

A further aspect of the disclosure provides a non-transitory machine-readable medium storing instructions. When executed by a controller including a processor and memory, the instructions cause the controller to perform a method for controlling optical states of an electrochromic device, the method being any one of the methods disclosed herein.

These and other objects and features of the present disclosure will become more fully apparent from the following description and appended claims, or may be learned by the practice of the disclosure as set forth hereinafter.

### BRIEF DESCRIPTION OF THE DRAWINGS

FIG. 1A shows a top-down view of an electrochromic device.

FIG. 1B is a graph showing a plot of a local voltage in a first transparent conductive layer and a local voltage in a second transparent conductive layer.

FIG. 1C is a graph showing a plot of V_{eff} across the electrochromic device.

FIG. 1D is a cross-sectional representation of an electrochromic lite.

FIG. 1E shows an end view of the electrochromic lite.

FIG. 1F shows a top-down view of the electrochromic lite.

FIG. 2A shows a cross-sectional schematic diagram of an electrochromic window.

FIG. 2B shows a cross-sectional schematic diagram of another electrochromic window.

FIG. 3A schematically depicts an electrochromic device in cross-section.

FIG. 3B is a schematic cross-section of an electrochromic device in a bleached state (or transitioning to a bleached state).

FIG. 3C is a schematic cross-section of electrochromic device in a colored state (or transitioning to a colored state).

FIG. 4 depicts a simplified block diagram of some components of a window controller and other components of a window controller system.

FIG. 5A shows a voltage control profile implemented by varying a voltage provided to an ECD.

FIG. 5B and FIG. 5C schematically illustrate voltage profiles of tint transitioning processes according to some implementations of the disclosure.

FIG. 5D schematically illustrate another voltage profile of a tint transitioning process.

FIG. 6A shows two voltage profiles and according to some implementations.

FIG. 6B shows an optical density profile of an ECD controlled by a method according to some implementations.

FIG. 7 shows data demonstrating improvements of tint transition speed and tint uniformity provided by a method according to some implementations.

FIG. 8 shows a flowchart for process for controlling an electrochromic device according to some implementations.

FIG. 9 shows a flowchart for process for controlling an electrochromic device.

FIG. 10 shows optical density during tint transition from T1 to T4 for an ECD having a bus bar distance of 59 inches.

FIG. 11 shows similar data of the ECD transitioning from T1 to T3.

FIG. 12 shows optical density of the ECD at four different stages of a tint transition process from T1 to T4 for ECDs of various sizes.

FIG. 13 shows data obtained from a tinting process that changed tint states of the ECDs from T1 to T3.

FIG. 14 shows data for tint transition from T1 to T4 comparing tinting performance between a method according to some implementations and a conventional method.

FIG. 15 shows comparative data for a tint transition process that changed ECD tint levels from T1 to T3.

FIG. 16 shows data comparing the time to reach steady state optical density target between the disclosed method according to some implementations and the conventional method.

FIG. 17 compares the drive time between the disclosed method and the conventional method.

FIG. 18 shows data of a method according to some implementations aimed to improve tint uniformity after the ECD has entered into a steady-state target optical density.

### DETAILED DESCRIPTION

The disclosed embodiments concern methods, apparatus, and systems for controlling tint transition of electrochromic devices and optically switchable windows.

Numeric ranges are inclusive of the numbers defining the range. It is intended that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

The terms “switchable window,” “optically switchable window,” “electrochromic window,” “smart window,” and “tintable window” are used interchangeably. They refer to an architectural window made of one or more electrochromic devices each comprising an electrochromic stack.

The terms “electrochromic device,” “optically switchable device,” and “dynamic glass” are used interchangeably herein. They refer to a device that changes optical state in response to electrical input. It reversibly cycles between two or more optical states. Switching between these states is controlled by applying predefined current and/or voltage to the device. The device typically includes two thin conductive sheets that straddle at least one optically active layer. The electrical input driving the change in optical state is applied to the thin conductive sheets. In certain implementations, the input is provided by bus bars in electrical communication with the conductive sheets.

“Bus bar” refers to an electrically conductive strip attached to a conductive layer such as a transparent conductive electrode spanning the area of an optically switchable device. The bus bar delivers electrical potential and current from an external lead to the conductive layer. An optically switchable device includes two or more bus bars, each connected to a single conductive layer of the device. In various embodiments, a bus bar forms a long thin line that spans most of the length of the length or width of a device. Often, a bus bar is located near the edge of the device.

“Applied Voltage” or Vₐₚₚ refers the difference in potential applied to two bus bars of opposite polarity on the electrochromic device. Each bus bar is electronically connected to a separate transparent conductive layer. The applied voltage may different magnitudes or functions such as driving an optical transition or holding an optical state. Between the transparent conductive layers are sandwiched the optically switchable device materials such as electrochromic materials. Each of the transparent conductive layers experiences a potential drop between the position where a bus bar is connected to it and a location remote from the bus bar. Generally, the greater the distance from the bus bar, the greater the potential drop in a transparent conducting layer. The local potential of the transparent conductive layers is often referred to herein as the V_{TCL}. Bus bars of opposite polarity may be laterally separated from one another across the face of an optically switchable device.

“Effective Voltage” or V_{eff} refers to the potential between the positive and negative transparent conducting layers at any particular location on the optically switchable device. In Cartesian space, the effective voltage is defined for a particular x, y coordinate on the device. At the point where V_{eff} is measured, the two transparent conducting layers are separated in the z-direction (by the device materials), but share the same x, y coordinate.

In this disclosure, the word “about” or “approximately,” when used to modify a numerical value or quantity, expands the coverage of the numerical value or quantity to a range from 10% below to 10% above the numerical value or quantity. For example, the phrase “a range of about 2 to 10 minutes” covers the range of 1.8 to 10.1 minutes.

The headings provided herein are not intended to limit the disclosure.

Unless defined otherwise herein, all technical and scientific terms used herein have the same meaning as commonly understood by one of ordinary skill in the art. Various scientific dictionaries that include the terms included herein are well known and available to those in the art. Although any methods and materials similar or equivalent to those described herein find use in the practice or testing of the embodiments disclosed herein, some methods and materials are described.

The terms defined immediately below are more fully described by reference to the Specification as a whole. It is to be understood that this disclosure is not limited to the particular methodology, protocols, and reagents described, as these may vary, depending upon the context they are used by those of skill in the art.

As used herein, the singular terms “a,” “an,” and “the” include the plural reference unless the context clearly indicates otherwise.

### I. INTRODUCTION

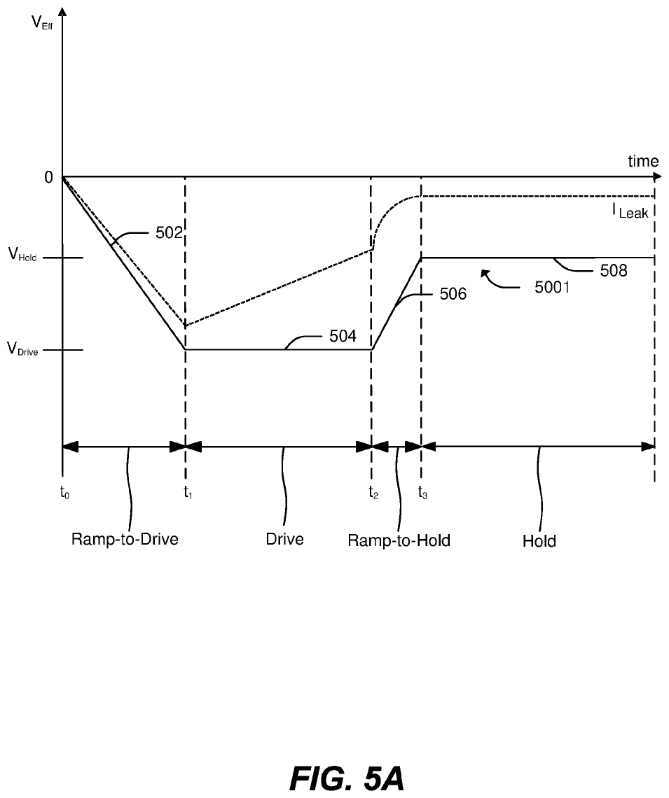

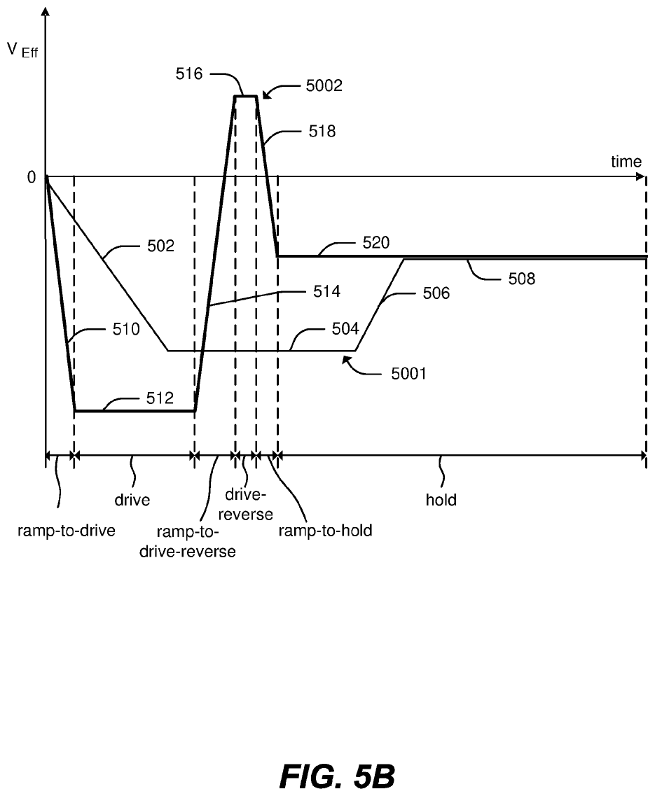

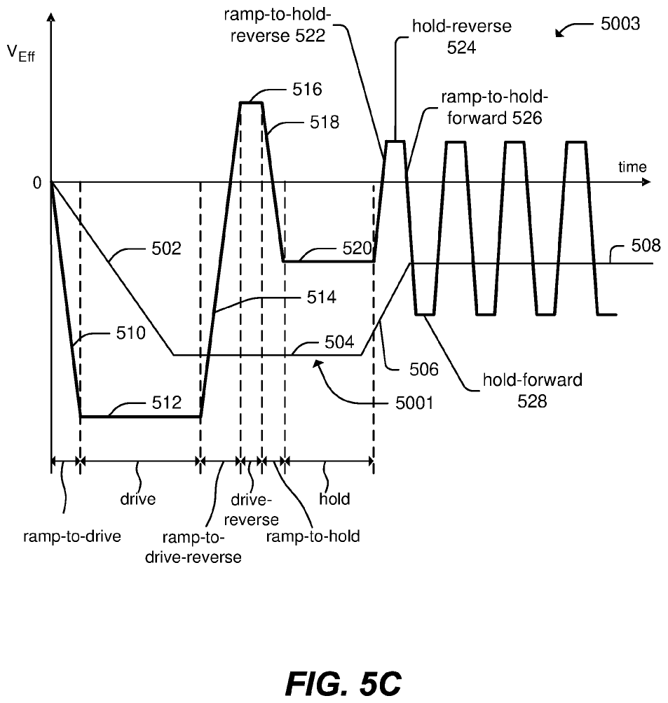

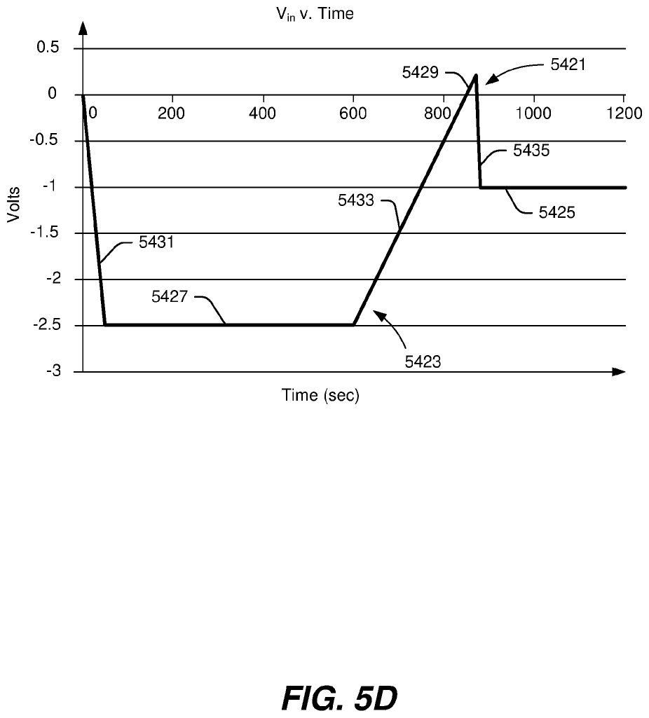

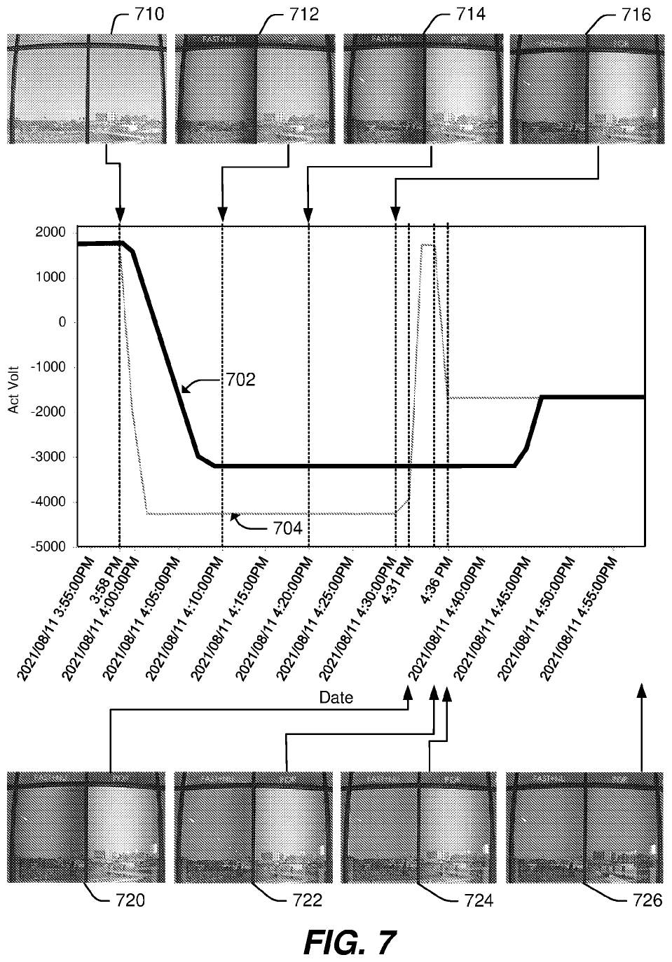

Switchable windows or electrochromic devices (ECDs) controlled by conventional methods suffer a number of problems that detract from user experience. First, the tint profile across the face of a windowpane tends to be uneven during a tint transitioning process, such as a transitioning process using a voltage profile shown in FIG. 5A. When the window is changing from clearer a state to a more tinted state, the tint levels tend to be darker at the two edges where two bus bars are located than in the center. When the window is changing from a more tinted states to a clearer state, the two edges of the windowpane tend to be clearer than the center. For example, FIG. 7 includes images 710-716 that show two windows transitioning from a clearer state to a more tinted state. During the transition, the windows are more tinted at the two vertical edges and clearer in the center of the windowpane.

As explained above, a voltage or current is applied to the electrochromic device across the two conductive layers of ECD to cause the electrochromic stacked to change tint state. FIG. 5A, further described hereinafter, shows voltage temporal profile 5001 used by a conventional method for changing the electrochromic stack of the ECD from a clearer state to a more tinted state. The electrical charge applied by bus bars to conductive layers of an ECD tends to gradually decrease from the bus bar towards the center of the windowpane. The electrical charge gradient may contribute to an uneven tint profile. Different materials and electrical properties of the conductive layer also may contribute to an uneven tint profile.

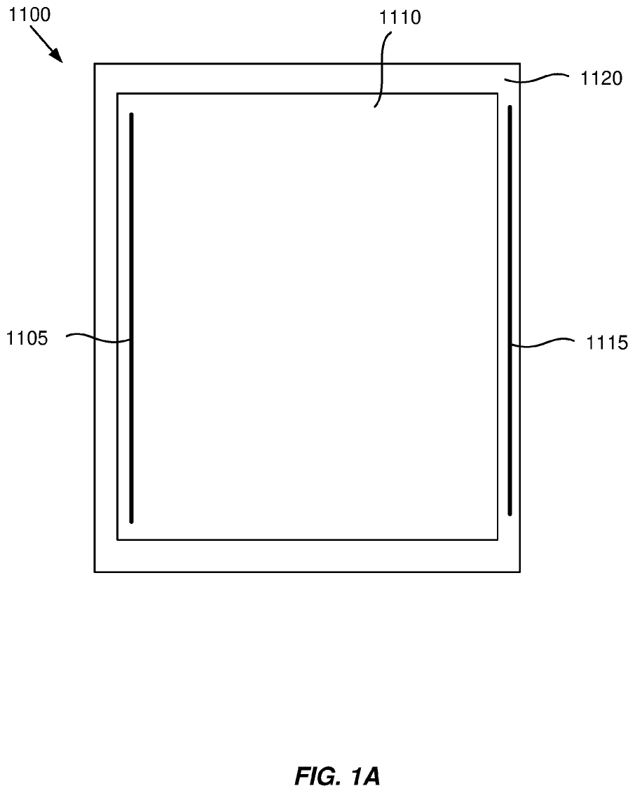

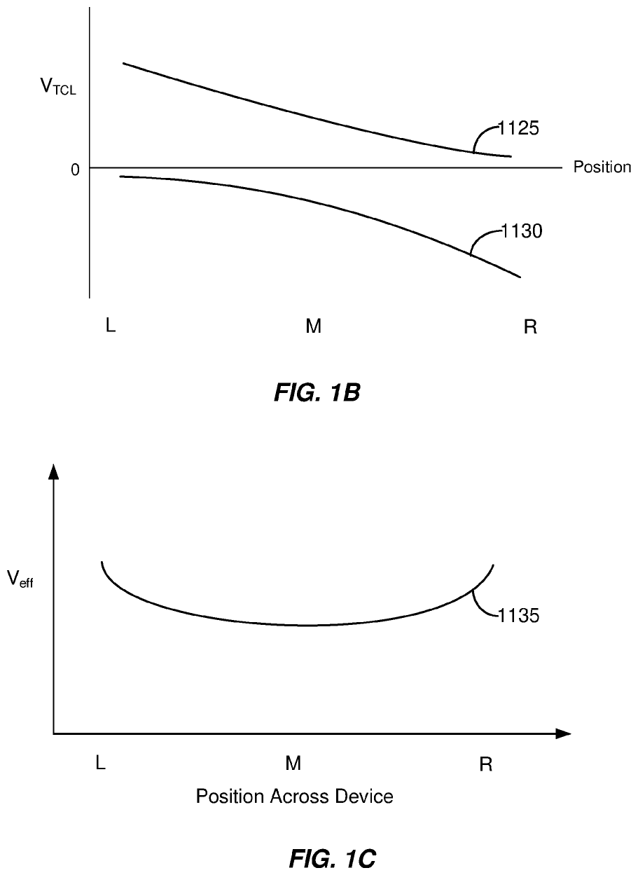

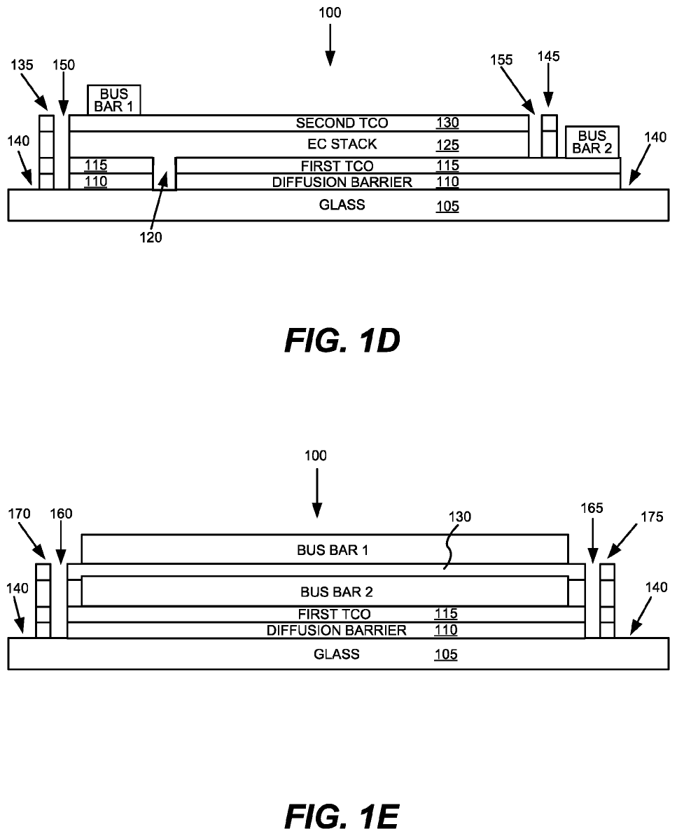

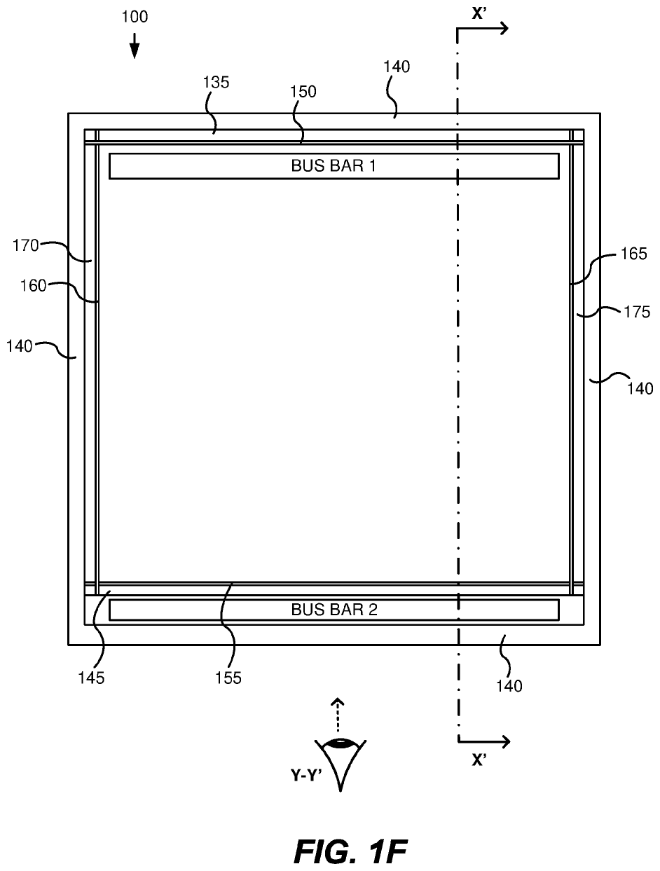

In various implementations, driving a transition in a typical electrochromic device is accomplished by applying a defined voltage to two separated bus bars on the device. In such a device, it is convenient to position bus bars perpendicular to the smaller dimension of a rectangular window (See FIG. 1A). This is because the transparent conducting layers used to deliver an applied voltage over the face of the thin film device have an associated sheet resistance, and the bus bar arrangement allows for the shortest span over which current must travel to cover the entire area of the device, thus lowering the time it takes for the conductor layers to be fully charged across their respective areas, and thus lowering the time to transition the device.

While an applied voltage, Vₐₚₚ, is supplied across the bus bars, essentially all areas of the device see a lower local effective voltage (V_{eff}) due to the sheet resistance of the transparent conducting layers and the current draw of the device. The center of the device (the position midway between the two bus bars) frequently has the lowest value of V_{eff}. This may result in an unacceptably small optical switching range and/or an unacceptably slow switching time in the center of the device. These problems may not exist at the edges of the device, nearer the bus bars. This is explained in more detail below with reference to FIGS. 1B and 1C.

FIG. 1A shows a top-down view of an electrochromic lite 1100 including bus bars having a planar configuration. Electrochromic lite 1100 includes a first bus bar 1105 disposed on a first conductive layer 1110 and a second bus bar 1115 disposed on a second conductive layer, 1120. An electrochromic stack (not shown) is sandwiched between first conductive layer 1110 and second conductive layer 1120. As shown, first bus bar 1105 may extend substantially across one side of first conductive layer 1110. Second bus bar 1115 may extend substantially across one side of second conductive layer 1120 opposite the side of electrochromic lite 1100 on which first bus bar 1105 is disposed. Some devices may have extra bus bars, e.g., on all four edges, but this complicates fabrication. A further discussion of bus bar configurations, including planar configured bus bars, is found in U.S. patent application Ser. No. 13/452,032 filed Apr. 20, 2012, which is incorporated herein by reference in its entirety.

FIG. 1B is a graph showing a plot of a local voltage in first transparent conductive layer 1110 and a voltage in second transparent conductive layer 1120 that drives the transition of electrochromic lite 1100 from a clear state to a tinted state, for example. Plot 1125 shows the local values of the voltage of the transparent conductive layer V_{TCL} in first transparent conductive layer 1110. As shown, the voltage drops from the left hand side (e.g., where first bus bar 1105 is disposed on first conductive layer 1110 and where the voltage is applied) to the right hand side of first conductive layer 1110 due to the sheet resistance and current passing through first conductive layer 1110. Plot 1130 also shows the local voltage V_{TCL} in second conductive layer 1120. As shown, the voltage increases (decreases in magnitude) from the right hand side (e.g., where second bus bar 1115 is disposed on second conductive layer 1120 and where the voltage is applied) to the left hand side of second conductive layer 1120 due to the sheet resistance of second conductive layer 1120. The value of the applied voltage, Vₐₚₚ, in this example is the difference in voltage between the right end of potential plot 130 and the left end of potential plot 1125. The value of the effective voltage, V_{eff}, at any location between the bus bars is the difference in values of curves 1130 and 1125 at the position on the x-axis corresponding to the location of interest.

FIG. 1C is a graph showing a plot of V_{eff} 1135 across the electrochromic device between first and second conductive layers 1110 and 1120 of electrochromic lite 1100. As explained, the effective voltage is the local voltage difference between the first conductive layer 1110 and the second conductive layer 1120. Regions of an electrochromic device subjected to higher effective voltages transition between optical states faster than regions subjected to lower effective voltages. As shown, the effective voltage is the lowest at the center of electrochromic lite 1100 and highest at the edges of electrochromic lite 1100. The voltage drop across the device is due to ohmic losses as current passes through the device. The voltage drop across large electrochromic windows can be alleviated by configuring additional bus bars within the viewing area of the window, in effect dividing one large optical window into multiple smaller electrochromic windows which can be driven in series or parallel. However, this approach may not be aesthetically appealing due to the contrast between the viewable area and the bus bar(s) in the viewable area. That is, it may be much more pleasing to the eye to have a monolithic electrochromic device without any distracting bus bars in the viewable area.

In the case of an electrochromic device with a planar bus bar, it can be shown that the V_{eff} across a device with planar bus bars is generally given by:

$$Δ V ( 0 ) = {V}_{app} - {RJL}^{2} / 2 \qquad ( Eqn . 1 )$$

$$Δ V ( L ) = {V}_{app} - {RJL}^{2} / 2$$

$$Δ V ( L / 2 ) = {V}_{app} - 3 {RJL}^{2} / 4$$

where:
Vₐₚₚ is the voltage difference applied to the bus bars to drive the electrochromic window;
ΔV(0) is V_{eff} at the bus bar connected to the first transparent conducting layer;
ΔV(L) is V_{eff} at the bus bar connected to the second transparent conducting layer;
ΔV(L/2) is V_{eff} at the center of the device, midway between the two planar bus bars;
R=transparent conducting layer sheet resistance;
J=instantaneous average current density; and
L=distance between the bus bars of the electrochromic device.

The transparent conducting layers are assumed to have substantially similar, if not the same, sheet resistance for the calculation. However, those of ordinary skill in the art will appreciate that the applicable physics of the ohmic voltage drop and local effective voltage still apply even if the transparent conducting layers have dissimilar sheet resistances.

As R, J or L increase, V_{eff} across the device decreases, thereby slowing or reducing the device coloration during transition and even in the final optical state.

In summary, it has been recognized that both transparent conducting layers experience ohmic drop, and that drop increases with distance from the associated bus bar, and therefore V_{TCL} decreases with distance from the bus bar for both transparent conductive layers. V_{eff} decreases in locations removed from both bus bars. This voltage profile, as shown in FIG. 1C, can lead to non-uniformity of the ECD. The center of a lite tends to transition more slowly than the edges, the center being less tinted when switching from a bleached state to a tinted state, and being more tinted when switching from a tinted state to a bleached state.

Some implementations of the disclosure solve the problem of uneven tint profile during tint transition by applying a reverse voltage pulse during, at the end of, or after the application of a drive voltage to the electrochromic device. Generally, the reverse voltage pulse is a voltage of a relatively short duration having a polarity opposite from the drive voltage and/or a magnitude smaller than the drive voltage. A clearing pulse is a reverse pulse that causes the ECD to become clearer. In the case of transitioning from a clearer state to a more tinted state, some implementations apply clearing a pulse during, at the end of, or after the application of a drive voltage.

Another problem with some switchable windows or ECDs and their control methods is the uneven tint profile of a window while the window is held in a steady tinted state. Some implementations of the disclosure solve this problem by periodically applying clearing pulses while the tinted window is in a hold state. The effective voltage applied to an ECD during a hold state has a voltage profile that is similar to the one shown in FIG. 1C, which contributes to the uneven tinting of the ECD.

In some instances, the problem of nonuniform tinting can be particularly pronounced or perceivable when the transition proceeds from a clearer state to a more tinted state. The human visual processing system can more easily detect nonuniformity in darker regions, such as those form at the edge of bus bars of a switchable window when the window undergoes a tinting transition. The human eye cannot as easily discern changes in the relatively clear realm of tint states. For example, if a window's initial tint state is 30% transmittance and the final tint state is 60% transmissivity, an observer may not as easily discern that the change is occurring or the tint levels are uneven across the windowpane. Therefore, in the context of this disclosure, most of the examples will be in the context of darkening occurring at the edges, near the bus bars, of a window. However, unless explicitly excluded, the disclosed embodiments also apply to transitions from more tinted states to clearer states.

For example, a switchable window may have 4 different tint states referred to as T1,T2, T3, and T4, going from light to dark, having different optical density or transmissivity levels. Uneven tint profiles are typically more pronounced during the transition from a lighter state to a darker state, for instance, from T1 to T4, T2 to T4, T3 to T4, T1 to T3, T2 to T3, and T1 to T2. Examples of T1-T4 tint states are described hereinafter. The nonuniform tint profile is less of a problem when the transition goes from a more tinted state to a clearer state. This may be particularly the case when the transition is from one relatively clear state to another relatively clear state, such as from tint 2 to tint 1. The nonuniform tint profile in many implementation is more severe when the end state of tint transition is relative dark, having a high optical density or low transmissivity. For example, the problem may be most pronounced when the transmissivity (% Tvis) is in the range of about 0.01%-50%, 0.1%-40%, 0.2%-30%, or 0.3%-25%, 0.4%-20%. In some implementations, the difference in the optical density (“OD”) between the center of the glass and the edge of the glass could be 0.5 OD to 1.5 OD. For example, if the center is at 1.22 OD (6% Tvis), the edge of the glass could be at 2.5 OD (0.32% Tvis) at the end of the drive step for a T1-T3 transition going from 55% Tvis to 6% Tvis.

While some of the examples and embodiments presented herein describe switchable windows having four tint states, this disclosure is not limited to such windows. For example, the disclosed embodiments also apply to windows having 2, 3, 4, 5, 6, 7, 8, 9, 10, or more tint states.

Yet another problem of some switchable windows or ECDs and their associated control methods may be a slow tint transition speed. Some implementations of the disclosure solve this problem by increasing the ramp-to-drive rate and/or increasing the magnitude of the drive voltage. Increasing the ramp-to-drive rate can hasten the start of the tint transition as perceived by an occupant of a building. Increasing the drive voltage magnitude can speed up the time to which the transition to a target tint level is complete. Thus, the speed of transition is increased by two different adjustments to the tint transition voltage profile 5001 of FIG. 5A. One of these adjustments, increasing the ramp-to-drive rate, speeds the time to which the user can detect the transition is starting. The other of these, increasing the magnitude of the drive voltage, speeds the completion of the overall tint transition.

### Electrochromic Devices

In order to orient the reader to the embodiments of systems and methods disclosed herein, a brief discussion of electrochromic devices and window controllers is provided. This initial discussion is provided for context only, and the subsequently described embodiments of systems, window controllers, and methods are not limited to the specific features and fabrication processes of this initial discussion.

A particular example of an electrochromic lite is described with reference to FIGS. 1D-1F, in order to illustrate embodiments described herein. FIG. 1D is a cross-sectional representation (see section cut X′-X′ of FIG. 1F) of an electrochromic lite 100, which is fabricated starting with a glass sheet 105. FIG. 1E shows an end view (see viewing perspective Y-Y′ of FIG. 1F) of electrochromic lite 100, and FIG. 1F shows a top-down view of electrochromic lite 100. FIG. 1D shows the electrochromic lite after fabrication on glass sheet 105, edge deleted to produce area 140, around the perimeter of the lite. The electrochromic lite has also been laser scribed and bus bars have been attached. A bus bar (also busbar) is a metallic strip or bar for distributing current. The glass lite 105 has a diffusion barrier 110, and a first transparent conducting oxide layer (TCO) 115, on the diffusion barrier. In this example, the edge deletion process removes both TCO 115 and diffusion barrier 110, but in other embodiments only the TCO is removed, leaving the diffusion barrier intact. The TCO 115 is the first of two conductive layers used to form the electrodes of the electrochromic device fabricated on the glass sheet. In this example, the glass sheet includes underlying glass and the diffusion barrier layer. Thus, in this example, the diffusion barrier is formed, and then the first TCO, an electrochromic stack 125, (e.g., having electrochromic, ion conductor, and counter electrode layers), and a second TCO 130, are formed. In one embodiment, the electrochromic device (electrochromic stack and second TCO) is fabricated in an integrated deposition system where the glass sheet does not leave the integrated deposition system at any time during fabrication of the stack. In one embodiment, the first TCO layer is also formed using the integrated deposition system where the glass sheet does not leave the integrated deposition system during deposition of the electrochromic stack and the (second) TCO layer. In one embodiment, all the layers (diffusion barrier, first TCO, electrochromic stack, and second TCO) are deposited in the integrated deposition system where the glass sheet does not leave the integrated deposition system during deposition. In this example, prior to deposition of electrochromic stack 125, an isolation trench 120, is cut through TCO 115 and diffusion barrier 110. Trench 120 is made in contemplation of electrically isolating an area of TCO 115 that will reside under bus bar 1 after fabrication is complete (see FIG. 1D). This is done to avoid charge buildup and coloration of the electrochromic device under the bus bar, which can be undesirable.

After formation of the electrochromic device, edge deletion processes and additional laser scribing are performed. FIG. 1D depicts areas 140 where the device has been removed, in this example, from a perimeter region surrounding laser scribe trenches 150, 155, 160, and 165. Trenches 150, 160 and 165 pass through the electrochromic stack and also through the first TCO and diffusion barrier. Trench 155 passes through second TCO 130 and the electrochromic stack, but not the first TCO 115. Laser scribe trenches 150, 155, 160, and 165 are made to isolate portions of the electrochromic device, 135, 145, 170, and 175, which were potentially damaged during edge deletion processes from the operable electrochromic device. In this example, laser scribe trenches 150, 160, and 165 pass through the first TCO to aid in isolation of the device (laser scribe trench 155 does not pass through the first TCO, otherwise it would cut off bus bar 2's electrical communication with the first TCO and thus the electrochromic stack). The laser or lasers used for the laser scribe processes are typically, but not necessarily, pulse-type lasers, for example, diode-pumped solid-state lasers. For example, the laser scribe processes can be performed using a suitable laser from IPG Photonics (of Oxford, Massachusetts), or from Ekspla (of Vilnius, Lithuania). Scribing can also be performed mechanically, for example, by a diamond tipped scribe. One of ordinary skill in the art would appreciate that the laser scribing processes can be performed at different depths and/or performed in a single process whereby the laser cutting depth is varied, or not, during a continuous path around the perimeter of the electrochromic device. In one embodiment, the edge deletion is performed to the depth of the first TCO.

After laser scribing is complete, bus bars are attached. Non-penetrating bus bar 1 is applied to the second TCO. Non-penetrating bus bar 2 is applied to an area where the device was not deposited (e.g., from a mask protecting the first TCO from device deposition), in contact with the first TCO or, in this example, where an edge deletion process (e.g., laser ablation using an apparatus having an XY or XYZ galvanometer) was used to remove material down to the first TCO. In this example, both bus bar 1 and bus bar 2 are non-penetrating bus bars. A penetrating bus bar is one that is typically pressed into and through the electrochromic stack to make contact with the TCO at the bottom of the stack. A non-penetrating bus bar is one that does not penetrate into the electrochromic stack layers, but rather makes electrical and physical contact on the surface of a conductive layer, for example, a TCO.

The TCO layers can be electrically connected using a non-traditional bus bar, for example, a bus bar fabricated with screen and lithography patterning methods. In one embodiment, electrical communication is established with the device's transparent conducting layers via silk screening (or using another patterning method) a conductive ink followed by heat curing or sintering the ink. Advantages to using the above described device configuration include simpler manufacturing, for example, and less laser scribing than conventional techniques which use penetrating bus bars.

After the bus bars are connected, the device is integrated into an insulated glass unit (IGU), which includes, for example, wiring for the bus bars and the like. In some embodiments, one or both of the bus bars are inside the finished IGU, however in one embodiment one bus bar is outside the seal of the IGU and one bus bar is inside the IGU. In the former embodiment, area 140 is used to make the seal with one face of the spacer used to form the IGU. Thus, the wires or other connection to the bus bars runs between the spacer and the glass. As many spacers are made of metal, e.g., stainless steel, which is conductive, it is desirable to take steps to avoid short circuiting due to electrical communication between the bus bar and connector thereto and the metal spacer. In the embodiments described herein, both of the bus bars are inside the primary seal of the finished IGU.

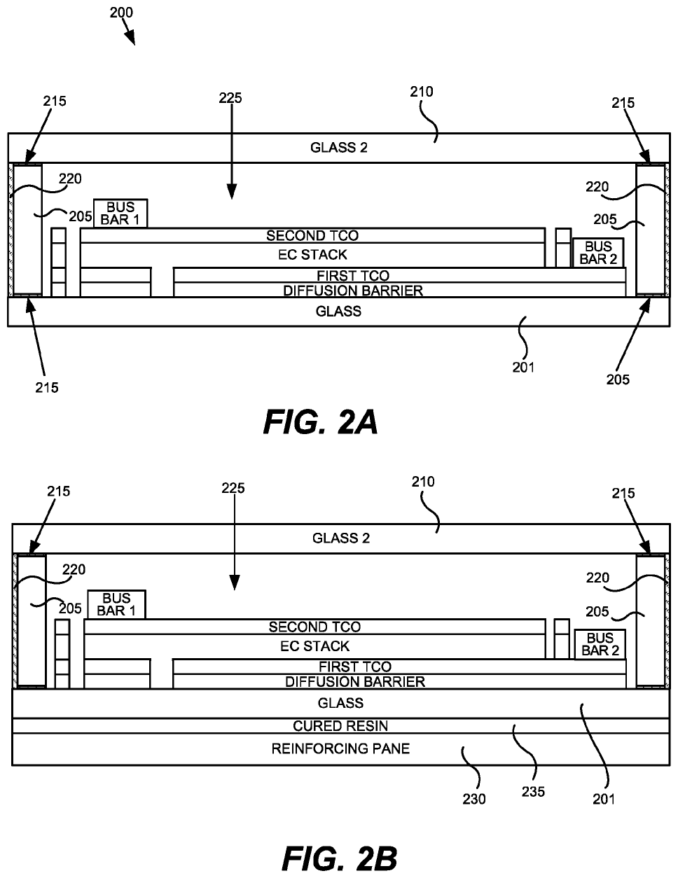

FIG. 2A shows a cross-sectional schematic diagram of the electrochromic window as described in relation to FIGS. 1D-1F integrated into an IGU 200. A spacer 205 is used to separate the electrochromic lite from a second lite 210. Second lite 210 in IGU 200 is a non-electrochromic lite, however, the embodiments disclosed herein are not so limited. For example, lite 210 can have an electrochromic device thereon and/or one or more coatings such as low-E coatings and the like. Lite 201 can be laminated glass, such as depicted in FIG. 2B (lite 201 is laminated to reinforcing pane 230, via resin 235). Between spacer 205 and the glass 201 of the electrochromic lite is a primary seal material 215. This primary seal material is also between spacer 205 and second glass lite 210. Around the perimeter of spacer 205 is a secondary seal 220. Bus bar wiring/leads traverse the seals for connection to a controller. Secondary seal 220 may be much thicker that depicted. These seals aid in keeping moisture out of an interior space 225, of the IGU. They also serve to prevent argon or other gas in the interior of the IGU from escaping.

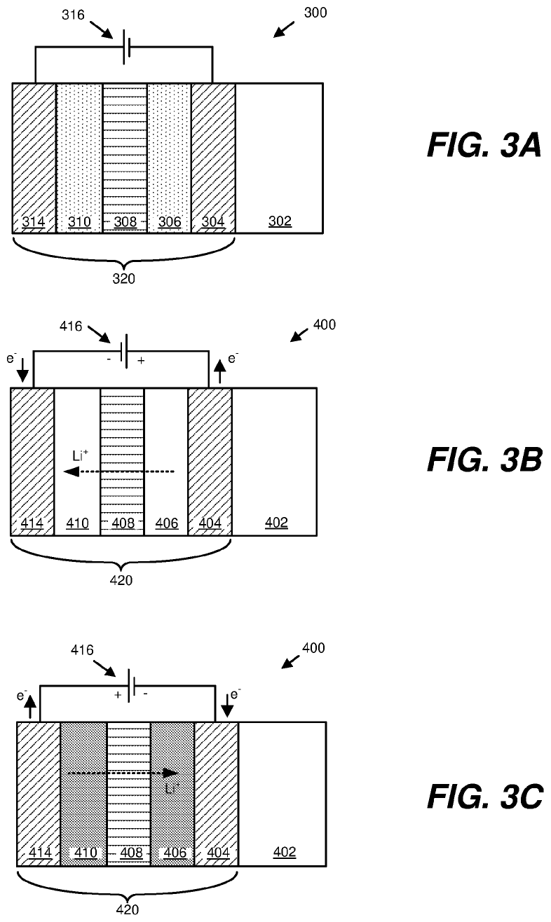

FIG. 3A schematically depicts an electrochromic device 300, in cross-section. Electrochromic device 300 includes a substrate 302, a first conductive layer (CL) 304, an electrochromic layer (EC) 306, an ion conducting layer (IC) 308, a counter electrode layer (CE) 310, and a second conductive layer (CL) 314. Layers 304, 306, 308, 310, and 314 are collectively referred to as an electrochromic stack 320. A voltage source 316 operable to apply an electric potential across electrochromic stack 320 effects the transition of the electrochromic device from, for example, a bleached state to a colored state (depicted). The order of layers can be reversed with respect to the substrate.

Electrochromic devices having distinct layers as described can be fabricated as all solid-state devices and/or all inorganic devices. Such devices and methods of fabricating them are described in more detail in U.S. patent application Ser. No. 12/645,111, titled “Fabrication of Low-Defectivity Electrochromic Devices,” filed on Dec. 22, 2009, and naming Mark Kozlowski et al. as inventors, and in U.S. patent application Ser. No. 12/645,159, titled “Electrochromic Devices,” filed on Dec. 22, 2009 and naming Zhongchun Wang et al. as inventors, both of which are hereby incorporated by reference in their entireties. It should be understood, however, that any one or more of the layers in the stack may contain some amount of organic material. The same can be said for liquids that may be present in one or more layers in small amounts. It should also be understood that solid state material may be deposited or otherwise formed by processes employing liquid components such as certain processes employing sol-gels or chemical vapor deposition.

Additionally, it should be understood that the reference to a transition between a bleached state and colored state is non-limiting and suggests only one example, among many, of an electrochromic transition that may be implemented. Unless otherwise specified herein (including the foregoing discussion), whenever reference is made to a bleached-colored transition (or equivalently a clear-tinted transition), the corresponding device or process encompasses other optical state transitions such as non-reflective-reflective, transparent-opaque, etc. Further, the term “bleached” or “clear” refers to an optically neutral state, for example, uncolored, transparent, or translucent. Still further, unless specified otherwise herein, the “color” or “tint” of an electrochromic transition is not limited to any particular wavelength or range of wavelengths. As understood by those of skill in the art, the choice of appropriate electrochromic and counter electrode materials governs the relevant optical transition.

In embodiments described herein, the electrochromic device reversibly cycles between a bleached/clear state and a colored/tinted state. In some cases, when the device is in a bleached state, a potential is applied to the electrochromic stack 320 such that available ions in the stack reside primarily in the counter electrode 310. When the potential on the electrochromic stack is reversed, the ions are transported across the ion conducting layer 308 to the electrochromic material 306 and cause the material to transition to the colored state. In a similar way, the electrochromic device of embodiments described herein can be reversibly cycled between different tint levels (e.g., bleached state, darkest colored state, and intermediate levels between the bleached state and the darkest colored state).

Referring again to FIG. 3A, voltage source 316 may be configured to operate in conjunction with radiant and other environmental sensors. As described herein, voltage source 316 interfaces with a device controller (not shown in this figure). Additionally, voltage source 316 may interface with an energy management system that controls the electrochromic device according to various criteria such as the time of year, time of day, and measured environmental conditions. Such an energy management system, in conjunction with large area electrochromic devices (e.g., an electrochromic window), can dramatically lower the energy consumption of a building.

Any material having suitable optical, electrical, thermal, and mechanical properties may be used as substrate 302. Such substrates include, for example, glass, plastic, and mirror materials. Suitable glasses include either clear or tinted soda lime glass, including soda lime float glass. The glass may be tempered or untempered.

In many cases, the substrate is a glass pane sized for residential window applications. The size of such glass pane can vary widely depending on the specific needs of the residence. In other cases, the substrate is architectural glass. Architectural glass is typically used in commercial buildings, but may also be used in residential buildings, and typically, though not necessarily, separates an indoor environment from an outdoor environment. In certain embodiments, architectural glass is at least 20 inches by 20 inches, and can be much larger, for example, as large as about 80 inches by 120 inches. Architectural glass is typically at least about 2 mm thick, typically between about 3 mm and about 6 mm thick. Of course, electrochromic devices are scalable to substrates smaller or larger than architectural glass. Further, the electrochromic device may be provided on a mirror of any size and shape.

On top of substrate 302 is conductive layer 304. In certain embodiments, one or both of the conductive layers 304 and 314 is inorganic and/or solid. Conductive layers 304 and 314 may be made from a number of different materials, including conductive oxides, thin metallic coatings, conductive metal nitrides, and composite conductors. Typically, conductive layers 304 and 314 are transparent at least in the range of wavelengths where electrochromism is exhibited by the electrochromic layer. Transparent conductive oxides include metal oxides and metal oxides doped with one or more metals. Examples of such metal oxides and doped metal oxides include indium oxide, indium tin oxide, doped indium oxide, tin oxide, doped tin oxide, zinc oxide, aluminum zinc oxide, doped zinc oxide, ruthenium oxide, doped ruthenium oxide and the like. Since oxides are often used for these layers, they are sometimes referred to as “transparent conductive oxide” (TCO) layers. Thin metallic coatings that are substantially transparent may also be used, as well as combinations of TCO's and metallic coatings.

In some embodiments, commercially available substrates such as glass substrates contain a transparent conductive layer coating. Such products may be used for both substrate and conductive layer. Examples of such glasses include conductive layer coated glasses sold under the trademark TEC Glass™ by Pilkington, of Toledo, Ohio and SUNGATE™ 300 and SUNGATE™ 500 by PPG Industries of Pittsburgh, Pennsylvania. TEC Glass™ is a glass coated with a fluorinated tin oxide conductive layer.

In some embodiments of the invention, the same conductive layer is used for both conductive layers (i.e., conductive layers). In some embodiments, different conductive materials are used for each conductive layers. For example, in some embodiments, TEC Glass™ is used for substrate (float glass) and conductive layer (fluorinated tin oxide) and indium tin oxide (ITO) is used for conductive layer. In some embodiments employing TEC Glass™ there is a sodium diffusion barrier between the glass substrate and TEC conductive layer.

The function of the conductive layers is to spread an electric potential provided by voltage source 316 over surfaces of the electrochromic stack 320 to interior regions of the stack, with relatively little ohmic potential drop. The electric potential is transferred to the conductive layers though electrical connections to the conductive layers. In some embodiments, bus bars, one in contact with conductive layer 304 and one in contact with conductive layer 314, provide the electric connection between the voltage source 316 and the conductive layers 304 and 314. The conductive layers 304 and 314 may also be connected to the voltage source 316 with other conventional means.

Overlaying conductive layer 304 is electrochromic layer 306. In some embodiments, electrochromic layer 306 is inorganic and/or solid. The electrochromic layer may contain any one or more of a number of different electrochromic materials, including metal oxides. Such metal oxides include tungsten oxide (WO₃), molybdenum oxide (MoO₃), niobium oxide (Nb₂O₅), titanium oxide (TiO₂), copper oxide (CuO), iridium oxide (Ir₂O₃), chromium oxide (Cr₂O₃), manganese oxide (Mn₂O₃), vanadium oxide (V₂O₅), nickel oxide (Ni₂O₃), cobalt oxide (Co₂O₃) and the like. During operation, electrochromic layer 306 transfers ions to and receives ions from counter electrode layer 310 to cause optical transitions.

Generally, the colorization (or change in any optical property-e.g., absorbance, reflectance, and transmittance) of the electrochromic material is caused by reversible ion insertion into the material (e.g., intercalation) and a corresponding injection of a charge balancing electron. Typically some fraction of the ions responsible for the optical transition is irreversibly bound up in the electrochromic material. Some or all of the irreversibly bound ions are used to compensate “blind charge” in the material. In most electrochromic materials, suitable ions include lithium ions (Li+) and hydrogen ions (H+) (that is, protons). In some cases, however, other ions will be suitable. In various embodiments, lithium ions are used to produce the electrochromic phenomena. Intercalation of lithium ions into tungsten oxide (WO_{3-y}(0<y≤˜0.3)) causes the tungsten oxide to change from transparent (bleached state) to blue (colored state).

Referring again to FIG. 3A, in electrochromic stack 320, ion conducting layer 308 is sandwiched between electrochromic layer 306 and counter electrode layer 310. In some embodiments, counter electrode layer 310 is inorganic and/or solid. The counter electrode layer may include one or more of a number of different materials that serve as a reservoir of ions when the electrochromic device is in the bleached state. During an electrochromic transition initiated by, for example, application of an appropriate electric potential, the counter electrode layer transfers some or all of the ions it holds to the electrochromic layer, changing the electrochromic layer to the colored state. Concurrently, in the case of NiWO, the counter electrode layer colors with the loss of ions.

In some embodiments, suitable materials for the counter electrode complementary to WO₃ include nickel oxide (NiO), nickel tungsten oxide (NiWO), nickel vanadium oxide, nickel chromium oxide, nickel aluminum oxide, nickel manganese oxide, nickel magnesium oxide, chromium oxide (Cr₂O₃), manganese oxide (MnO₂), and Prussian blue.

When charge is removed from a counter electrode 310 made of nickel tungsten oxide (that is, ions are transported from counter electrode 310 to electrochromic layer 306), the counter electrode layer will transition from a transparent state to a colored state.

In the depicted electrochromic device, between electrochromic layer 306 and counter electrode layer 310, there is the ion conducting layer 308. Ion conducting layer 308 serves as a medium through which ions are transported (in the manner of an electrolyte) when the electrochromic device transitions between the bleached state and the colored state. Preferably, ion conducting layer 308 is highly conductive to the relevant ions for the electrochromic and the counter electrode layers, but has sufficiently low electron conductivity that negligible electron transfer takes place during normal operation. A thin ion conducting layer with high ionic conductivity permits fast ion conduction and hence fast switching for high performance electrochromic devices. In certain embodiments, the ion conducting layer 308 is inorganic and/or solid.

Examples of suitable ion conducting layers (for electrochromic devices having a distinct IC layer) include silicates, silicon oxides, tungsten oxides, tantalum oxides, niobium oxides, and borates. These materials may be doped with different dopants, including lithium. Lithium doped silicon oxides include lithium silicon-aluminum-oxide. In some embodiments, the ion conducting layer includes a silicate-based structure. In some embodiments, a silicon-aluminum-oxide (SiAlO) is used for the ion conducting layer 308.

Electrochromic device 300 may include one or more additional layers (not shown), such as one or more passive layers. Passive layers used to improve certain optical properties may be included in electrochromic device 300. Passive layers for providing moisture or scratch resistance may also be included in electrochromic device 300. For example, the conductive layers may be treated with anti-reflective or protective oxide or nitride layers. Other passive layers may serve to hermetically seal electrochromic device 300.

FIG. 3B is a schematic cross-section of an electrochromic device in a bleached state (or transitioning to a bleached state). In accordance with specific embodiments, an electrochromic device 400 includes a tungsten oxide electrochromic layer (EC) 406 and a nickel-tungsten oxide counter electrode layer (CE) 410. Electrochromic device 400 also includes a substrate 402, a conductive layer (CL) 404, an ion conducting layer (IC) 408, and conductive layer (CL) 414.

A power source 416 is configured to apply a potential and/or current to an electrochromic stack 420 through suitable connections (e.g., bus bars) to the conductive layers 404 and 414. In some embodiments, the voltage source is configured to apply a potential of a few volts in order to drive a transition of the device from one optical state to another. The polarity of the potential as shown in FIG. 3B is such that the ions (lithium ions in this example) primarily reside (as indicated by the dashed arrow) in nickel-tungsten oxide counter electrode layer 410

FIG. 3C is a schematic cross-section of electrochromic device 400 shown in FIG. 3B but in a colored state (or transitioning to a colored state). In FIG. 3C, the polarity of voltage source 416 is reversed, so that the electrochromic layer is made more positive to accept additional lithium ions, and thereby transition to the colored state. As indicated by the dashed arrow, lithium ions are transported across ion conducting layer 408 to tungsten oxide electrochromic layer 406. Tungsten oxide electrochromic layer 406 is shown in the colored state. Nickel-tungsten oxide counter electrode 410 is also shown in the colored state. As explained, nickel-tungsten oxide becomes progressively more opaque as it gives up (deintercalates) lithium ions. In this example, there is a synergistic effect where the transition to colored states for both layers 406 and 410 are additive toward reducing the amount of light transmitted through the stack and substrate.

As described above, an electrochromic device may include an electrochromic (EC) layer and a counter electrode (CE) layer separated by an ionically conductive (IC) layer that is highly conductive to ions and highly resistive to electrons. As conventionally understood, the ionically conductive layer therefore prevents shorting between the electrochromic layer and the counter electrode layer. The ionically conductive layer allows the electrochromic and counter electrode layers to hold a charge and thereby maintain their bleached or colored states. In electrochromic devices having distinct layers, the components form a stack which includes the ion conducting layer sandwiched between the electrochromic electrode layer and the counter electrode layer. The boundaries between these three stack components are defined by abrupt changes in composition and/or microstructure. Thus, the devices have three distinct layers with two abrupt interfaces.

In accordance with certain embodiments, the counter electrode and electrochromic layers are formed immediately adjacent one another, sometimes in direct contact, without separately depositing an ionically conducting layer. In some embodiments, electrochromic devices having an interfacial region rather than a distinct IC layer are employed. Such devices, and methods of fabricating them, are described in U.S. Pat. No. 8,300,298 and U.S. patent application Ser. No. 12/772,075 filed on Apr. 30, 2010, and U.S. patent application Ser. No. 12/814,277 and Ser. No. 12/814,279, filed on Jun. 11, 2010—each of the three patent applications and patent is titled “Electrochromic Devices,” each names Zhongchun Wang et al. as inventors, and each is incorporated by reference herein in its entirety.

### II. WINDOW CONTROLLERS

A window controller is used to control the tint level of the electrochromic device of an electrochromic window. In some embodiments, the window controller is able to transition the electrochromic window between two tint states (levels), a bleached state and a colored state. In other embodiments, the controller can additionally transition the electrochromic window (e.g., having a single electrochromic device) to intermediate tint levels. In some disclosed embodiments, the window controller is able to transition the electrochromic window to four or more tint levels. Certain electrochromic windows allow intermediate tint levels by using two (or more) electrochromic lites in a single IGU, where each lite is a two-state lite.

In some embodiments, an electrochromic window can include an electrochromic device (e.g., electrochromic device 400 in FIG. 3B) on one lite of an IGU (e.g., IGU 200 in FIG. 2A) and another electrochromic device (e.g., electrochromic device 400 in FIG. 3B) on the other lite of the IGU. If the window controller is able to transition each electrochromic device between two states, a bleached state and a colored state, the electrochromic window is able to attain four different states (tint levels), a colored state with both electrochromic devices being colored, a first intermediate state with one electrochromic device being colored, a second intermediate state with the other electrochromic device being colored, and a bleached state with both electrochromic devices being bleached. Embodiments of multi-pane electrochromic windows are further described in U.S. Pat. No. 8,270,059, naming Robin Friedman et al. as inventors, titled “MULTI-PANE ELECTROCHROMIC WINDOWS,” which is hereby incorporated by reference in its entirety.

In some embodiments, the window controller is able to transition an electrochromic window having an electrochromic device capable of transitioning between two or more tint levels. For example, a window controller may be able to transition the electrochromic window to a bleached state, one or more intermediate levels, and a colored state. In some other embodiments, the window controller is able to transition an electrochromic window incorporating an electrochromic device between any number of tint levels between the bleached state and the colored state. Embodiments of methods and controllers for transitioning an electrochromic window to an intermediate tint level or levels are further described in U.S. Pat. No. 8,254,013, naming Disha Mehtani et al. as inventors, titled “CONTROLLING TRANSITIONS IN OPTICALLY SWITCHABLE DEVICES,” which is hereby incorporated by reference in its entirety.

In some embodiments, a window controller can power one or more electrochromic devices in an electrochromic window. Typically, this function of the window controller is augmented with one or more other functions described in more detail below. Window controllers described herein are not limited to those that have the function of powering an electrochromic device to which it is associated for the purposes of control. That is, the power source for the electrochromic window may be separate from the window controller, where the controller has its own power source and directs application of power from the window power source to the window. However, it is convenient to include a power source with the window controller and to configure the controller to power the window directly, because it obviates the need for separate wiring for powering the electrochromic window.

Further, the window controllers described in this section are described as standalone controllers which may be configured to control the functions of a single window or a plurality of electrochromic windows, without integration of the window controller into a building control network or a building management system (BMS). Window controllers, however, may be integrated into a building control network or a BMS.

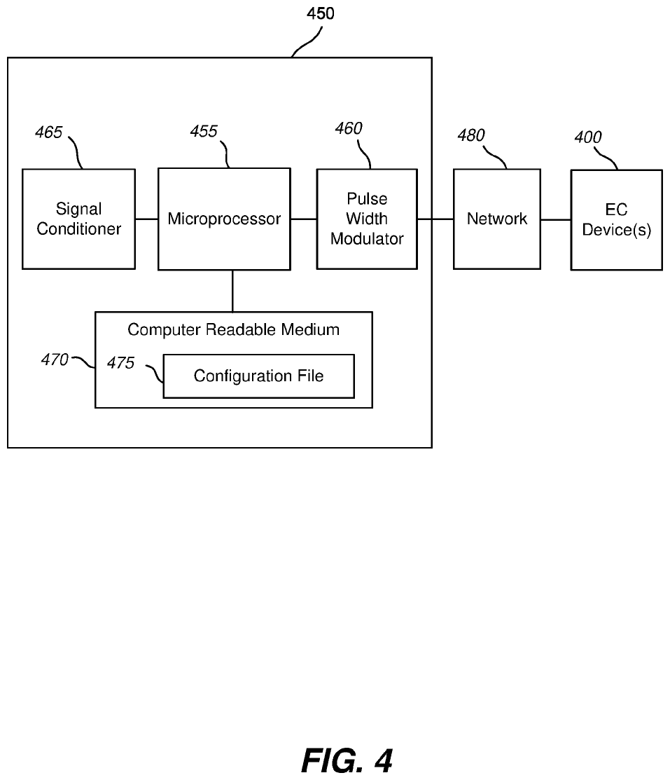

FIG. 4 depicts a simplified block diagram of some components of a window controller 450 and other components of a window controller system of disclosed embodiments. More detail of components of window controllers can be found in U.S. patent application Ser. No. 13/449,248 and Ser. No. 13/449,251, both naming Stephen Brown as inventor, both titled “CONTROLLER FOR OPTICALLY-SWITCHABLE WINDOWS,” and both filed on Apr. 17, 2012, and in U.S. patent Ser. No. 13/449,235, titled “CONTROLLING TRANSITIONS IN OPTICALLY SWITCHABLE DEVICES,” naming Stephen Brown et al. as inventors and filed on Apr. 17, 2012, all of which are hereby incorporated by reference in their entireties.

In FIG. 4, the illustrated components of the window controller 450 include a microprocessor 455 or other processor, a pulse width modulator 460, one or more input 465, and a computer readable medium 470 (e.g., memory) having a configuration file 475. Window controller 450 is in electronic communication with one or more electrochromic devices 400 in an electrochromic window through network 480 (wired or wireless) to send instructions to the one or more electrochromic devices 400. In some embodiments, the window controller 450 may be a local window controller in communication through a network (wired or wireless) to a master window controller.

In disclosed embodiments, window controller 450 can instruct the PWM 460, to apply a voltage and/or current to electrochromic window 505 to transition it to any one of four or more different tint levels. In disclosed embodiments, electrochromic window 505 can be transitioned to at least eight different tint levels described as: 0 (lightest), 5, 10, 15, 20, 25, 30, and 35 (darkest). The tint levels may linearly correspond to visual transmittance values and solar heat gain coefficient (SHGC) values of light transmitted through the electrochromic window 505. For example, using the above eight tint levels, the lightest tint level of 0 may correspond to an SHGC value of 0.80, the tint level of 5 may correspond to an SHGC value of 0.70, the tint level of 10 may correspond to an SHGC value of 0.60, the tint level of 15 may correspond to an SHGC value of 0.50, the tint level of 20 may correspond to an SHGC value of 0.40, the tint level of 25 may correspond to an SHGC value of 0.30, the tint level of 30 may correspond to an SHGC value of 0.20, and the tint level of 35 (darkest) may correspond to an SHGC value of 0.10.

Window controller 450 or a master controller in communication with the window controller 450 may employ any one or more predictive control logic components to determine a desired tint level based on signals from the exterior sensor 510 and/or other input. The window controller 450 can instruct the PWM 460 to apply a voltage and/or current to electrochromic window 505 to transition it to the desired tint level.

It should be understood that control logic and other logic used to implement techniques described above can be implemented in the form of circuits, processors (including general purpose microprocessors, digital signal processors, application specific integrated circuits, programmable logic such as field-programmable gate arrays, etc.), computers, computer software, devices such as sensors, or combinations thereof. Based on the disclosure and teachings provided herein, a person of ordinary skill in the art will know and appreciate other ways and/or methods to implement the disclosed techniques using hardware and/or a combination of hardware and software.

Any of the components or functions of software, firmware, or machine-instructions described in this application, may be implemented as code to be executed by a processor using any suitable computer language such as, for example, Java, C++ or Python using, for example, conventional or object-oriented techniques. The code may be stored as a series of instructions, or commands on a computer or machine readable medium, such as a random-access memory (RAM), a read only memory (ROM), a programmable memory (EEPROM), a magnetic medium such as a hard-drive or a floppy disk, or an optical medium such as a CD-ROM. Any such computer or machine readable medium may reside on or within a single computational apparatus, and may be present on or within different computational apparatuses within a system or network. In some implementations, the computer or machine readable medium is a non-transitory medium.

In some embodiments disclosed herein, one or more electrochromic devices are operatively coupled to at least one controller and/or processor. A controller may comprise a processing unit (e.g., CPU or GPU). A controller may receive an input (e.g., from at least one device or projected media). The controller may comprise circuitry, electrical wiring, optical wiring, socket, and/or outlet. A controller may receive an input and/or deliver an output. A controller may comprise multiple (e.g., sub-)controllers. An operation (e.g., as disclosed herein) may be performed by a single controller or by a plurality of controllers. At least two operations may be each preconformed by a different controller. At least two operations may be preconformed by the same controller. A device and/or media may be controlled by a single controller or by a plurality of controllers. At least two devices and/or media may be controlled by a different controller. At least two devices and/or media may be controlled by the same controller. The controller may be a part of a control system. The control system may comprise a master controller, floor (e.g., comprising network controller) controller, or a local controller. The local controller may be a target controller. For example, the local controller may be a window controller (e.g., controlling an optically switchable window), enclosure controller, or component controller. The controller may be a part of a hierarchal control system. The hierarchal control system may comprise a main controller that directs one or more controllers, e.g., floor controllers, local controllers (e.g., window controllers), enclosure controllers, and/or component controllers. The target may comprise a device or a media. The device may comprise an electrochromic window, a sensor, an emitter, an antenna, a receiver, a transceiver, or an actuator.

In some examples, a controlled apparatus is a tintable window (e.g., an electrochromic window). In some embodiments, a dynamic state of an electrochromic window is controlled by altering a voltage signal to an electrochromic device (ECD) used to provide tinting or coloring. An electrochromic window can be manufactured, configured, or otherwise provided as an insulated glass unit (IGU). IGUs may serve as the fundamental constructs for holding electrochromic panes (also referred to as “lites”) when provided for installation in a building. An IGU lite or pane may be a single substrate or a multi-substrate construct, such as a laminate of two substrates.

The controller may be implemented in an electronic device in various forms of digital computers such as a laptop computer, a desktop computer, a workstation, a personal digital assistant, a server, a blade server, a mainframe computer, and other appropriate computers. The electronic device may also represent various forms of mobile apparatuses such as personal digital assistant, a cellular telephone, a smart phone, a wearable device and other similar computing apparatuses. The parts shown herein, their connections and relationships, and their functions are only as examples, and not intended to limit implementations of the present disclosure as described and/or claimed herein.

In some implementations, the controller is coupled to memory, such as a non-transitory computer-readable or machine-readable medium. The memory stores instructions for the controller to operate a ECD using methods disclosed herein. In some implementations, the controller comprises a processor. The memory, as a non-transitory computer readable storage medium, may be used to store non-transitory software programs, non-transitory computer executable programs and modules, such as program instructions/modules corresponding to the method for controlling an ECD in the embodiments of the present disclosure. The processor executes the non-transitory software programs, instructions, and modules stored in the memory to execute various functional applications and data processing.

The memory may include a storage program area and a storage data area, where the storage program area may store an operating system and at least one function required application program; and the storage data area may store data created by the use of the electronic device according to the disclosed methods. In addition, the memory may include a high-speed random access memory, and may also include a non-transitory memory, such as at least one magnetic disk storage device, a flash memory device, or other non-transitory solid-state storage devices. In some embodiments, the memory may optionally include memories remotely provided with respect to the processor, and these remote memories may be connected to the electronic device of the method for controller the ECD. Examples of the above network include but are not limited to the Internet, intranet, local area network, mobile communication network, and combinations thereof.

### III. VOLTAGE PROFILES FOR TINT TRANSITION

FIG. 5A shows an example of a control profile 5001 as a voltage control profile implemented by varying a voltage provided to an ECD. For example, the solid line in FIG. 5A represents an effective voltage V_{Eff} applied across the ECD over the course of a tinting transition and a subsequent maintenance period. The solid line can represent the relative difference in the electrical voltages V_{App1} and V_{App2} applied to the two conducting layers of the ECD. The dotted line in FIG. 5A represents a corresponding current (I) through the device. In the illustrated example, the voltage control profile 5001 includes four periods or stages: a ramp-to-drive period that initiates the transition, a drive period that continues to drive the transition, a ramp-to-hold period, and subsequent hold period.

In FIG. 5A, the ramp-to-drive period is characterized by the application of a voltage ramp 502 that increases in magnitude from an initial value at time t₀ to a maximum driving value of V_{Drive} at time t₁. For example, the ramp-to-drive period can be defined by three drive parameters known or set by the window controller: the initial voltage at t₀ (the current voltage across the ECD at the start of the transition), the magnitude of V_{Drive} (governing the ending optical state), and the time duration during which the ramp is applied (dictating the speed of the transition). The window controller may also set a target ramp rate, a maximum ramp rate or a type of ramp (for example, a linear ramp, a second degree ramp or an n^{th}-degree ramp). In some embodiments, the ramp rate can be limited to avoid damaging the ECD.

In FIG. 5A, the drive period includes application of a constant voltage V_{Drive} 504 starting at time t₁ and ending at time t₂, at which point the ending optical state is reached (or approximately reached). The ramp-to-hold period is characterized by the application of a voltage ramp 506 that decreases in magnitude from the drive value V_{Drive} at time t₂ to a minimum hold value of V_{Hold} at time t₃. In some embodiments, the ramp-to-hold period can be defined by three drive parameters known or set by the window controller: the drive voltage V_{Drive}, the hold voltage V_{Hold}, and the time duration during which the ramp is applied. The window controller may also set a ramp rate or a type of ramp (for example, a linear ramp, a second degree ramp or an n^{th}-degree ramp).

In FIG. 5A, the hold period is characterized by the application of a constant voltage V_{Hold} starting at time t₃. The hold voltage V_{Hold} may be used to maintain the ECD at the ending optical state. As such, the duration of the application of the hold voltage V_{hold} may be concomitant with the duration of time that the ECD is to be held in the ending optical state. For example, because of non-idealities associated with the ECD, a leakage current I_{Leak} can result in the slow drainage of electrical charge from the ECD. Such a drainage of electrical charge can result in a corresponding reversal of ions across the ECD, and consequently, a slow reversal of the optical transition. The hold voltage V_{Hold} can be continuously applied to counter or prevent the leakage current. In some embodiments, the hold voltage V_{Hold} is applied periodically to “refresh” the desired optical state, or in other words, to bring the ECD back to the desired optical state.

As further described hereinafter, certain aspects of the disclosed embodiments differ from the voltage profile of FIG. 5A by including one or more clearing pulses that have an opposite polarity from the drive voltage and/or the hold voltage. In some implementations, one or more clearing pulses are applied after the drive voltage and before the onset of the hold voltage. In some implementations, one or more clearing pulses are applied after the onset of the hold voltage.

FIG. 5B, FIG. 5C, and FIG. 5D schematically illustrate voltage profiles of tint transitioning processes according to some implementations of the disclosure. FIG. 5B includes a voltage profile 5001 same as that in FIG. 5A for comparison and illustration purposes, and also includes a voltage profile 5002 according to some implementations of the disclosure. As discussed in more detail below, the voltage profile 5002 includes a clearing pulse in accordance with disclosed embodiments. As can be seen, the voltage profile 5002 includes a ramp-to-drive voltage 510 in the ramp-to-drive period. The ramp rate of the ramp-to-drive voltage 510 is higher than the ramp rate of the ramp-to-drive voltage 502 of voltage profile 5001.

As further shown in FIG. 5B, the voltage profile 5002 also includes a drive voltage 512 in the drive period. The magnitude of the drive voltage 512 is higher than the drive voltage 504 of the voltage profile 5001.

Voltage profile 5002 in FIG. 5B further includes a clearing pulse after the drive voltage is applied. Here, this clearing pulse includes a ramp-to-drive-reverse voltage 514 in the ramp-to-drive-reverse period, a drive-reverse voltage 516 in the drive-reverse period, and ramp-to-hold voltage 518 in the ramp-to-hold period. The ramp-to-drive-reverse voltage 514 increases from the drive voltage 512 to the drive-reverse voltage 516. In the depicted embodiment, the drive-reverse voltage 516 has a polarity that is opposite from the polarity of the drive voltage 512. The drive-reverse voltage 516 is applied in the drive-reverse period. Here with voltage profile 5002, the polarity of the drive-reverse voltage 516 is positive while the polarity of the drive voltage 512 is negative. In such implementations, the polarity of the ramp-to-drive-reverse voltage changes during the ramp-to-drive-reverse voltage period. In other implementations, the drive-reverse voltage 516 may have the same polarity as the drive voltage 512, but with a smaller magnitude than the drive voltage 512. The voltage profile 5002 also includes a ramp-to-hold voltage 518 in the ramp-to-hold time period, which is after the drive-reverse period. Ramp-to-hold voltage 518 changes from the drive-reverse voltage 516 to a hold voltage 520. Voltage profile 5002 also includes the hold voltage 520 remaining substantially constant (e.g., a coefficient of variation <0.1) during the hold period.

As explained above with reference to FIG. 1C, the effective voltage at the two edges of an ECD is larger in magnitude than at the center of the ECD. As a result, the drive voltage 512 can cause the edges of the ECD to become darker than the center of the ECD. The drive-reverse voltage 516 has an opposite polarity from the drive voltage 512. The drive-reverse voltage 516 also generates effective voltages of larger magnitudes at the edges than at the center. Applying the drive-reverse voltage 516 for a brief period after applying the drive voltage 512 clears the edges of the ECD, thereby improving edge-to-center uniformity of tinting of the ECD.

In some implementations, each voltage profile component may vary on various parameters or characteristics of the window, such as a function of the size of the window. The magnitude and/or duration of any of the voltage profile components may be tied to one or more characteristics of a window such as distance between two bus bars of a window (or bus bar distance), the length of the window's bus bar, and the aspect ratio (length to width) of rectangular windows.

In some implementations, each voltage profile component may vary for different window types that include, for example, different numbers of bus bars, different angles of bus bars, composite bus bars that may have a window divided into different segments, or a combination thereof.

In some implementations, the drive voltage 512 applied during the drive period may vary based on bus bar distance (BBD). For example, the following drive voltage values may be used in some embodiments for tinting transitions of windows having different BBDs:
BBD of approximately 14″=−2280 mV
BBD of approximately 20″=−2289 mV
BBD of approximately 30″=−2390 mV
BBD of approximately 40″=−2600 mV
BBD of approximately 48″=−4135 mV
BBD of approximately 60″=−4316 mV
BBD of approximately 72″=−4526 mV

In some implementations, voltage profiles (not shown here) are used for clearing ECDs instead of tinting the ECDS and the drive voltage applied during the drive period is positive. In some such implementations, the following drive voltage values may be used for clearing transitions of windows having different BBDs.
BBD of approximately 14″=1432 mV
BBD of approximately 20″=1473 mV
BBD of approximately 30″=1541 mV
BBD of approximately 40″=1609 mV
BBD of approximately 48″=1664 mV
BBD of approximately 60″=1747 mV
BBD of approximately 72″=1831 mV

Some implementations use drive voltage values that are in a range of about +/−5% of the above values for the corresponding BBDs. Some implementations use drive voltages that are in a range of about +/−10% of the above values for the corresponding BBDs. Some implementations use drive voltages that are in a range of about +/−20% of the above values for the corresponding BBDs. Some implementations use drive voltages that are in a range of about +/−30% of the above values for the corresponding BBDs. Some implementations use drive voltages that are in a range of about +/−50% of the above values for the corresponding BBDs.

The drive-reverse voltage 516 of the voltage profile 5002 has an opposite plurality as the drive voltage. In some implementations, the magnitude of the drive-reverse voltage 516 is in the range of 1400 to 2600 mV. In some implementations, the drive-reverse voltage 516 magnitude may be different for different target tint level. In some implementations, the duration of drive-reverse voltage may be different for different target tint level. In various implementations, the duration of the drive-reverse voltage 516 is about 30 seconds to 6 minutes.

The voltage profile 5002 of FIG. 5B also includes the hold voltage 520, which has an amplitude that is smaller than drive voltage 512. The hold voltage is applied to maintain a target tint state. In some implementations, the hold voltage 512 is similar to a hold voltage used in a conventional voltage profile. In some implementations, hold voltage 521 may be implemented as different voltage values for different target tint states.

When a ECD is in a target tint state other than a baseline tint state, if no voltage is applied to the ECD, electrons and lithium ions gradually exchange between the electrode layer and the counter electrode layer, generating a leakage current that gradually reversing the ECD to the baseline tint state. The hold voltage compensates for the leakage current at the target tint state, thereby holding the ECD at the target tint state. In various implementations, various tint states, expressed as % transmissivity or a Tvis percentage, use the following nominal hold voltages.
Tvis of about 40%=−250 mV
Tvis of about 30%=−350 mV
Tvis of about 6%=−900 mV
Tvis of about 1%=−1400 mV
Tvis of about 0.5%=−1650 mV

Some implementations use hold voltages that are in a range of about +/−5% of the above values for the respective tint levels. Some implementations use hold voltages that are in a range of about +/−10% of the above values for the respective tint levels. Some implementations use hold voltages that are in a range of about +/−20% of the above values for the respective tint levels. Some implementations use hold voltages that are in a range of about +/−30% of the above values for the respective tint levels. Some implementations use hold voltages that are in a range of about +/−40% of the above values for the respective tint levels. Some implementations use hold voltages that are in a range of about +/−50% of the above values for the respective tint levels.

The ramp rates for the various ramp periods described herein may have various characteristics, in certain embodiments. In some implementations, like illustrated in FIG. 5B, the ramp rate of the ramp-to-drive 510 is between about 10 mV/s to about 250 mV/s, the ramp rate for the ramp-to-drive-reverse voltage 514 may be between about 10 mV/s to about 250 mV/s, and/or the ramp rate of the ramp-to-hold voltage 518 may be between about 10 mV/s and about 250 mV/s. The ramp rates of ramp-to-drive voltage 510, ramp-to-drive-reverse voltage 514, and ramp-to-hold voltage 518 are all constant in voltage profile 5002. However, in various implementations of the disclosure, these ramp rates may be variable, while the average ramp rate for a period fall in the ranges described above. These various characteristics of ramp rates are also applicable to ramp rates of other voltage profiles of various implementations described herein, including but not limited to the voltage profiles of FIGS. 5C, 5D, 6A, 6B, and 7-9.

In some implementations, the tint transitioning process applies a voltage profile that includes all portions of voltage profile 5002 of FIG. 5B. In other implementations, however, the tint transitioning process applies a voltage profile that includes some, but not all, aspects of voltage provide 5002. For example, some implementations may include the ramp-to-drive voltage 510, the drive voltage 512, the drive-reverse voltage 516, and the hold voltage 520, and the ramp-to-drive-reverse voltage 514 and/or the ramp-to-hold voltage 518 may be optional and omitted. When a ramp voltage is not included in the voltage profile, it can be replaced with a “vertical” voltage that has the ramp rate above a criterion. Two consecutive constant voltages having different amplitude can transition instantaneously or in a very short period of time, forming a step like profile. However, the voltage rate of change in such a transition is above criteria for “ramping” voltages as disclosed herein. In various implementations, the ramping voltage described herein requires a ramp rate of less than about 20,000, 10,000, 5,000, 2,000, or 1,000 mV/s.

The voltage profile 5002 illustrated in FIG. 5B may be for implementations that cause a window to transition from a clearer tint state to a more tinted state. For some other implementations that change the tint states in an opposite direction, the voltage profile would be inversed in polarity. For example, in FIG. 5B the drive voltage 512 of voltage profile 5002 causes the ECD to become more tinted and the drive-reverse voltage 516 causes the ECD to become clearer. Inversely, for a clearing voltage profile used to change the ECD from a more tinted state to a clearer state, the drive voltage causes the ECD to become clearer, while the drive-reverse voltage causes the ECD to become more tinted. In various implementations, the clearing voltage profile used to change the ECD from a more tinted state to a clearer state has a form that is similar to the voltage profile 5002 being flipped upside down around the V_{Eff}=0 line. The clearing voltage profile has a drive voltage, a drive-reverse voltage, and a hold voltage of opposite polarities from the corresponding voltages of the voltage profile 5002.

The drive reverse voltage 516 and its adjacent voltage 514 and 518 are also referred to as a drive-reverse pulse, or a clearing pulse because it changes the ECD to a clearer state. The voltage profile 5002 includes only one drive-reverse voltage 516. However, in some implementations of the disclosure, the voltage profile may include two or more drive-reverse pulses. Two consecutive drive-reverse pulses may be separated by an interval. In various implementations, the interval ranges from about 1 to 3600 seconds, about 10 to 60 seconds, about 20 to 60 seconds, about 10 to 60 seconds, about 600 to 3600 seconds, about 1200 to 3600 seconds.

To summarize some of the advantages of voltage profile 5002, first, the ramp rate of the ramp-to-drive voltage 510 of voltage profile 5002 can advantageously cause the optical density to start transitioning sooner than other voltage transition techniques. Ramp-to-drive voltage 510 has a higher ramp rate than ramp-to-drive voltage 502 of voltage profile 5001. Ramp-to-drive voltage 510 reaches drive voltage 512 sooner than ramp-to-drive voltage 502 reaching drive voltage of 504. As a result, using voltage profile 5002 can cause an ECD to start increasing optical density at an earlier time than using the voltage profile 5001. Second, voltage profile 5002 includes a drive voltage 512 having a magnitude larger than drive voltage 504, which can cause the electrochromic device to reach its target optical density sooner, helping to speed up the completion of tint transition. Third, voltage profile 5002 includes drive-reverse voltage 516, which reduces the optical density of the electrochromic device at its edges near bus bars, helping to improve the uniformity of tint levels across the pane of the electrochromic device.

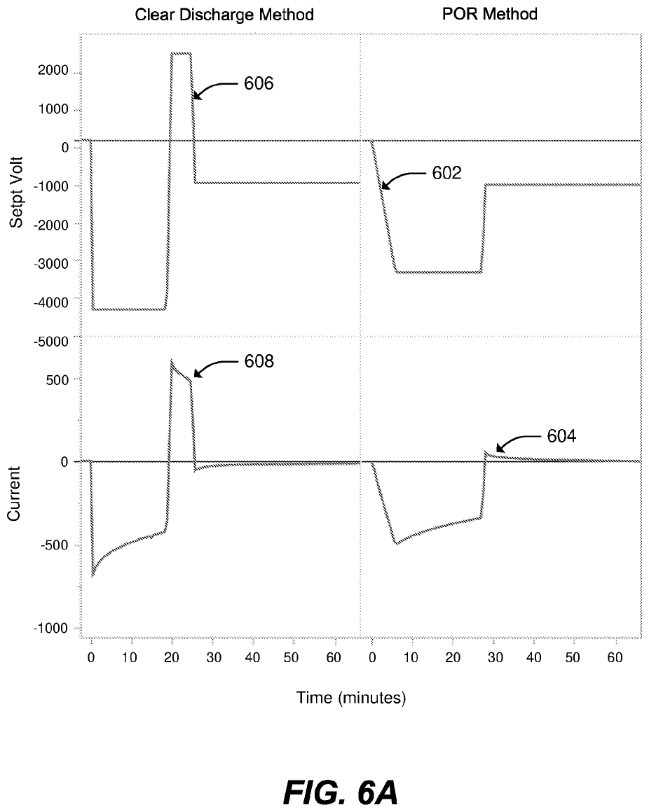

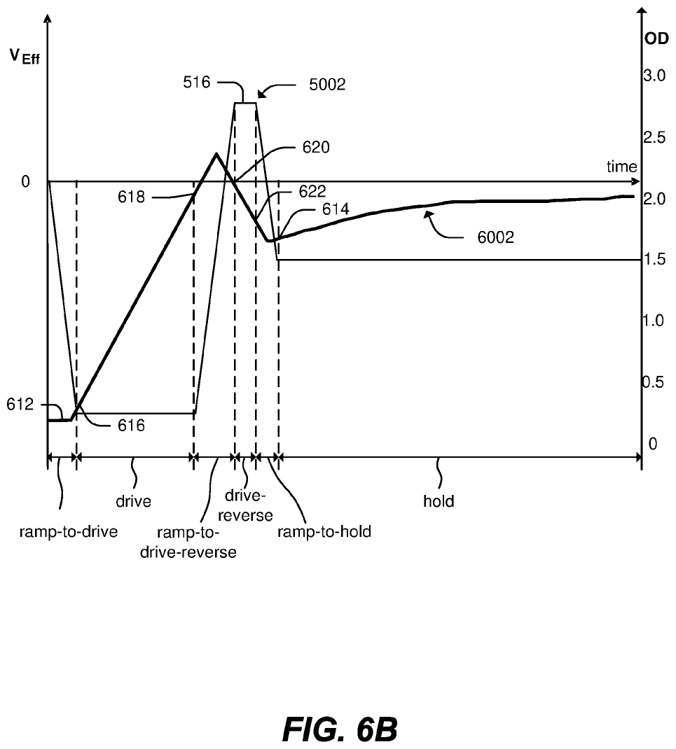

While FIGS. 5A and 5B illustrate voltage profiles used for transitioning ECDs in some applications, FIG. 6A illustrates current profiles associated with voltage profiles corresponding to the voltage profiles of FIGS. 5A and 5B. FIG. 6A shows two voltage profiles 602 and 606 in the top half, which are respectively comparable to the voltage profile 5001 of FIG. 5A and the voltage profile 5002 of FIG. 5B. The bottom half of FIG. 6A shows current profiles 604 and 608 corresponding to voltage profiles 602 and 606, respectively.

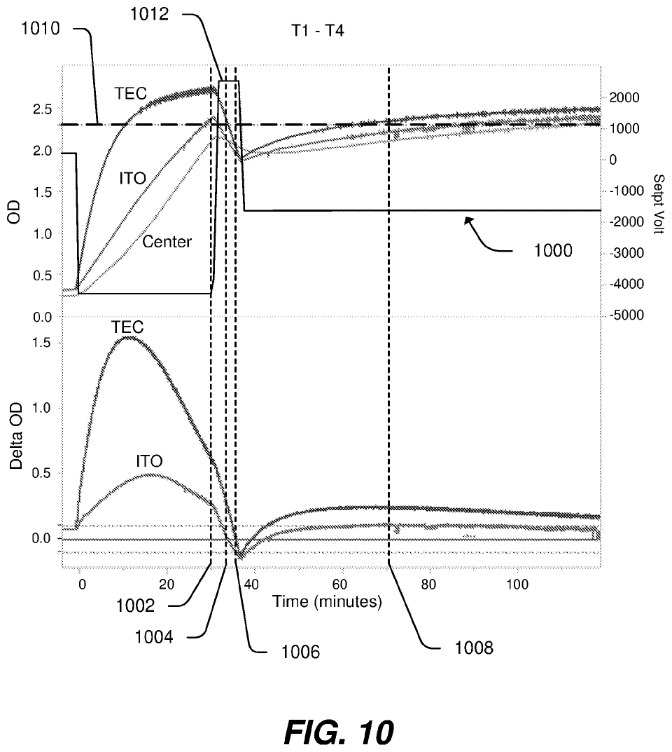

While FIG. 5B illustrates the voltage profile 5002 used for transitioning ECDs in some implementations, FIG. 6B shows an optical density (OD) profile 6002 of an ECD at an edge near a bus bar in a tint transitioning process caused by the voltage profile 5002 according to some implementations. For a comparison of OD between edges and center of an ECD, see, e.g., FIGS. 10-15. This Figure includes an OD profile 6002 overlaid with the voltage profile 5002 of FIG. 5B. The right vertical axis indicates optical density (OD), and the left vertical axis indicates effective voltage (V_{eff}). The OD profile 6002 here represents the ECD's OD at an edge near a bus bar as the voltages are applied and changes according to the voltage profile of FIG. 5B. As explained in more detail, the OD profile 6002 illustrates that the voltage clearing pulse including the drive-reverse voltage 516 causes the OD to reduce its optical density, which, when applied with a larger effective voltage to two edges of the ECD than to the center of the ECD, helps to reduce edge-to-center non-uniformity. As seen in the optical density profile 6002, the optical density of the ECD is relatively flat in the ramp-to-drive period, and starts to rise near the end of the period. The optical density continues to rise in the drive period, increasing from point 616 to point 618 on optical density profile 6002. The optical density of the ECD first increases and then decreases in the ramp-to-drive-reverse period, from point 618 to 620. The optical density profile 6002 continues to decrease in the drive-reverse period from point 620 to point 622. The voltage profile 5002 applies a drive-reverse voltage 516 in the drive-reverse period. As explained above with reference to FIG. 1C, the effective voltage is higher at the two edges of the ECD near the bus bars than at the center, the drive-reverse voltage has a larger effective voltage at the two edges of the ECD. Thus, the drive-reverse voltage 516 effectively clears the edges of the ECD and improves edge-to-center uniformity of the ECD. In the ramp-to-hold period, the optical density further decreases and then stabilizes. At the beginning of the hold period, the optical density of the ECD (point 614 on optical density profile 6002) is lower than at the end of the drive period (point 618 on optical density profile 6002, when two edges of the ECD tend to be darker than the center of the ECD as further explained herein after with reference to FIG. 7, image 716). The drive-reverse voltage helps to reduce the optical density of the edges of the ECD where bus bars are located, helping to improve the uniformity of tinting on the surface of the ECD. During the hold period, the optical density of the ECD increases slightly, but remains relatively steady.

As seen in FIG. 6B, the optical density of the ECD is lower at the beginning of the ramp-to-drive period (point 612) than at the beginning of the hold period (point 614), indicating that the tint transitioning process darkens the ECD. Moreover, the ECD's optical density at the beginning of the hold period (point 614) is higher than the optical density of the ECD at the beginning of the drive period (point 616) but is lower than the optical density at the end of the drive period (point 618), indicating that the tint transitioning process first darkens the ECD during the drive period and then lightens the ECD in the drive-reverse period.

Similar to the embodiments of FIG. 5B described above, FIG. 5C shows a voltage profile 5003 according to some implementations of the disclosure and the conventional voltage profile 5001 (the same as voltage profile 5001 in FIG. 5A). The voltage profile 5001 is shown for comparison purpose. Voltage profile 5003 is similar to voltage profile 5002 in FIG. 5B, both profiles including the same voltage segments including ramp-to-drive voltage 510, drive voltage 512, ramp-to-drive-reverse voltage 514, drive-reverse voltage 516, ramp-to-hold voltage 518, and hold voltage 520. Various characteristics and features of these components of voltage profile 5002 described above with reference to FIG. 5B are also applicable to the corresponding components of voltage profile 5003 of FIG. 5C in various implementations.

Voltage profile 5003 is different from voltage profile 5002 of FIG. 5B in that it includes four instances of hold-reverse voltage 524 and four instances of hold-forward voltages 528. Hold-reverse voltage 524 has the polarity that is opposite from hold voltage 520. In alternative implementations, a hold-reverse voltage has a same polarity as but a smaller magnitude than a hold voltage. Hold-forward voltage 528 has a same polarity and a larger magnitude than hold voltage 520. These instances of hold-reverse voltage 524 and hold-forward voltage 528 alternate and form an oscillation above and below the hold voltage 520.

Hold-reverse voltage 524 has a magnitude in a range of about −4000 to 2000 mV. The duration of hold-reverse voltage 524 is in a range of about 2 to 10 minutes. Similarly, hold-forward voltage 528 has a magnitude in a range of about −4000 to 2000 mV and a duration in a range from about 2 to 10 minutes. The magnitude and duration of hold-reverse voltage 524 and hold-forward voltage 528 may be adjusted for different target steady tint levels. They may also be adjusted for different window sizes.

Voltage profile 5003 includes ramp-to-hold-reverse voltage 522 that changes with a ramp rate in the range of 10-250 mV/s until reaching the hold-reverse voltage 524. In some implementations, the ramp rate of ramp-to-hold-reverse voltage 522 is about 50 mV/s. Voltage profile 5003 includes four instances of ramp-to-hold-reverse voltages and four instances of hold-reverse voltages. Moreover, voltage profile files 5003 includes four ramp-to-hold-forward voltages and four hold-forward voltages. Ramp-to-hold-forward voltage 526 changes from hold-reverse voltage 524 to hold-forward voltage 528 with a ramp rate of about to 250 mV/s. In some implementations, the ramp rate of ramp-to-hold-forward voltage 526 is about 50 mV/s.

In some implementations, a method of controlling an ECD employs a voltage profile that includes ramp-to-drive voltage 510, drive voltage 512, hold voltage 520, and hold-reverse voltage 524, remaining segments of profile 5003 being optional. If a ramp voltage connecting to constant voltages is removed from a profile, a step-like portion of the profile is formed by the two constant voltages. In some implementations, the methods employs the voltage profile that includes ramp-to-drive voltage 510, drive voltage 510, drive-reverse voltage 516, hold voltage 520, hold-reverse voltage 524, and hold-forward voltage 528, remaining segments of profile 5003 being optional. Some implementations apply a voltage profile that includes all segments of voltage profile 5003.

Similar to the embodiments of FIG. 5B described above, FIG. 5D schematically illustrates a voltage profile 5421 of a tint transitioning process according to some implementations of the disclosure. Here in FIG. 5D, a voltage profile 5421 is used to tint an ECD to a desired tint state and also includes a clearing voltage pulse. In some implementations, a voltage profile is used to transition an ECD to an intermediate state, as illustrated in FIG. 5D. Here, voltage profile 5421 includes an initial voltage pulse 5423 that has a magnitude at level 5427 essentially as great as that applied to reach an end state is applied initially. Thereafter, the applied voltage is dropped to a level 5425 corresponding to that of the desired intermediate state. In a specific embodiment, the applied voltage at this level is delivered in oscillating fashion as described above, such as with respect to FIG. 5C. While an oscillating voltage centered on level 5425 is not discernible from FIG. 5D, it may be present nevertheless. In various embodiments, the oscillation may be asymmetric.

In some cases, the total duration of the initial high voltage pulse used to reach the intermediate state using this control sequence is typically between about 1 and 30 minutes or more specifically between about 3 and 15 minutes or even more specifically between about 8 and 11 minutes. Of course, the duration will depend on the desired end state (the level of coloration for the intermediate state), the device size, the leakage current, etc. Further, in some cases, the magnitude of this initial pulse is (on average) about 1 to 7 volts, and more specifically about 1 to 4 volts. Of course, the coloration thresholds, sheet resistances, coloration speed and leakage current characteristics will differ between systems, so these magnitudes and other characteristics are not intended to be limiting.

It has been observed that the intermediate state coloration time may be about 4× greater for a control sequence that does not employ an initial high voltage pulse in comparison to a control sequence that employs such pulse.

It should be noted that a control algorithm such as that presented in FIG. 5D permits a relatively uniform edge to center optical transition between states. Higher voltages result in faster switching but also exaggerate the non-uniformity between center and edge. On the other hand, lower voltages produce slower switching but transition more uniformly. By carefully choosing the magnitude of an initial applied voltage pulse, optical transitions in electrochromic devices achieve a balance between uniformity and speed.

The voltage profile 5421 of FIG. 5D is similar to the voltage profile 5002 of FIG. 5B, both profiles including a drive voltage (5427 and 512, respectively) and a hold voltage (5425 and 520, respectively). The drive voltage has a polarity and an magnitude that causes an ECD to transition from a first tint state to a second tint state. In some implementations, the drive voltage has a substantially constant magnitude. The hold voltage 5425 has a magnitude that maintains the ECD in the second tint state. In some implementations, the hold voltage 5425 has a polarity opposite a trail-end voltage 5429 as further described below.

Moreover, the voltage profile 5421 includes a leading edge ramp voltage 5431 corresponding to the ramp-to-drive voltage 510 of the voltage profile 5002. Also, the voltage profile 5421 includes a trailing edge ramp voltage 5433 corresponding to the ramp-to-drive-reverse voltage 514 of the voltage profile 5002. Further, the voltage profile 5421 includes a ramp-to-hold voltage 5435 corresponding to the ramp-to-hold voltage 518 of the voltage profile 5002. Various characteristics and features of these components of voltage profile 5002 described above with reference to FIG. 5B are also applicable to the corresponding components of voltage profile 5421 of FIG. 5D in some implementations.

The leading edge ramp voltage 5431 of the voltage profile 5421 is applied before the drive voltage 5427 and has a direction and polarity that causes the electrochromic device to switch in the direction of the transition.

The trailing edge ramp voltage 5433 is applied after the drive voltage 5427 and before hold voltage 5425. It has a direction opposite that of the leading edge ramp voltage 5431 and reaches a trail-end voltage 5429 having a polarity opposite that of the leading edge ramp voltage 5431. In some implementations, trail-end voltage 5429 has a polarity opposite the hold voltage 5425.

The leading edge ramp voltage 5431, the drive voltage 5427, and the trailing edge ramp voltage 5433 form a voltage pulse 5423. The trailing edge ramp voltage 5433 and the ramp-to-hold voltage 5435 form a clearing pulse having a peak at the trail-end voltage 5429.

Unlike the voltage profile 5002, the clearing pulse of the voltage profile 5421 does not include a substantially constant voltage between the trailing edge ramp voltage 5433 and the ramp-to-hold voltage 5435. In contrast, the clearing pulse of the voltage profile 5002 of FIG. 5B includes a substantially constant drive-reverse voltage 516 between the ramp-to-drive-reverse voltage 514 and the ramp-to-hold voltage 518. Also, various corresponding components of the voltage profile 5421 and the voltage profile 5002 may have different magnitudes, ramp rates, and durations.

In some implementations, a method of controlling an ECD uses voltage profile 5421. The method includes applying the voltage pulse 5423 to the electrochromic device to initiate a transition between a first tint state and a second tint state of the electrochromic device. The method also includes, after applying the voltage pulse 5423, applying the hold voltage 5425 to the electrochromic device.

In some implementations, the voltage pulse 5423 includes a drive voltage 5427 after the leading edge ramp voltage 5431 and before the trailing edge ramp voltage 5433, the drive voltage 5427 having a substantially constant magnitude. In some implementations, the magnitude of the hold voltage 5425 is smaller than the magnitude of the drive voltage 5427. In some implementations, the trail-end voltage 5429 has a polarity opposite the polarities of the drive voltage 5427 and the hold voltage 5425.

In some implementations, the hold voltage 5425 includes an oscillatory voltage. In some implementations, the oscillatory voltage improves an edge to center uniformity of tint state on the electrochromic device.

In some implementations, the voltage pulse 5423 has a duration of between about 1 and 30 minutes. In some implementations, the voltage pulse 5423 has a magnitude of about 1 to 7 volts. In some implementations, the hold voltage 5425 and the trail-end voltage 5429 have opposite polarities. In some implementations, the trailing edge ramp voltage has a ramp rate that ranges from about 10 μV/s to about 100 V/s. In some implementations, the trailing edge ramp voltage has a ramp rate that ranges from about 10 μV/s to about 10 V/s. In some implementations, the trailing edge ramp voltage has a ramp rate that ranges from about 10 μV/s to about 1 V/s. In some implementations, the trailing edge ramp voltage has a ramp rate that ranges from about 10 μV/s to about 1 mV/s. In some implementations, the trailing edge ramp voltage has a ramp rate that ranges from about 1 mV/s to about 1 V/s. In some implementations, the trailing edge ramp voltage has a ramp rate that ranges from about 1 mV/s to about 10 V/s.

The voltage control profiles illustrated and described with reference to FIGS. 5A-5D are only examples of a voltage control profile. However, many other profiles may be desirable or suitable. These other profiles also can readily be achieved using the controllers and optically switchable devices disclosed herein. For example, a current profile can be applied instead of a voltage profile. In some embodiments, a current control profile similar to that of the current profile 608 or current profile 604 shown in FIG. 6A can be applied. In some applications, a control profile can have more than four periods. For example, a voltage control profile can include one or more overdrive periods. For example, the voltage ramp applied during the ramp-to-drive period can increase in magnitude beyond the drive voltage V_{Drive} to an overdrive voltage VOD. The ramp-to-drive period may be followed by a ramp period during which the applied voltage decreases from the overdrive voltage VOD to the drive voltage V_{Drive}. In some embodiments, the overdrive voltage VOD can be applied for a relatively short time duration before the ramp back down to the drive voltage V_{Drive}.

In some embodiments, the applied voltage or current profiles are interrupted for relatively short durations of time to provide open circuit conditions across the device. While such open circuit conditions are in effect, an actual voltage or other electrical characteristics can be measured, detected, or otherwise determined to monitor how far along an optical transition has progressed, and in some instances, to determine whether changes in the profile are desirable. Such open circuit conditions also can be provided during a hold period to determine whether a hold voltage V_{Hold} should be applied or whether a magnitude of the hold voltage V_{Hold} should be changed. Examples related to controlling optical transitions is provided in International Patent Application Serial No. PCT/US14/43514, filed Jun. 20, 2014, titled “CONTROLLING TRANSITIONS IN OPTICALLY SWITCHABLE DEVICES,” which is hereby incorporated by reference in its entirety.

FIG. 7 shows experimental data demonstrating improvements of tint transition speed and tint uniformity provided by a method according to some implementations of the disclosure. Here in FIG. 7, voltage profile 702 is similar to voltage profile 5001 of FIG. 5A, which are voltage profiles used by some conventional methods and voltage profile 704 is similar to voltage profile 5002 in FIG. 5B, which are used by methods according to some implementations of the disclosure. The images 710-726 show tint states of two switchable windows side-by-side. The window on the left in each image was controlled using voltage profile 704 (e.g., 5002 of FIG. 5B). The window on the right was controlled by voltage profile 702 (e.g., 5001 of FIG. 5A). Image 710 was taken at 3:58 PM, the time right before voltages were applied to the windows to change their tint state. Both windows were in a clear state. Images 712, 714, and 716 were taken at 4:10 PM, 4:20 PM, and 4:30 PM, respectively, in a period when both voltage profile 704 and voltage profile 702 were applying a drive voltage.

As can be seen in image 712, for example, taken at an early time of the drive period of the disclosed method, the window on the left being controlled by the method according to some implementations (e.g., that of FIGS. 5B and 5D) was more tinted than the window on the right controlled by the conventional method, indicating that the disclosed method provides an earlier onset of tint transition than the conventional method. Image 714, taken at an intermediate time of the drive period of the disclosed method, shows that the window on the left controlled by the disclosed method was more tinted than the window on the right controlled by the conventional method. Image 716, taken at the end of the drive period of voltage profile 704 of the disclosed method, shows that the window on the left controlled by the disclosed method was sufficiently darkened to exceed the target tint state. The window on the right controlled by a conventional method at this time in image 716 is significantly less tinted than the window on the left controlled by the disclosed method. The difference between the two windows demonstrates that the disclosed method took less time to reach or exceed target tint levels than the conventional method.

As can be seen in both windows in all three images 712, 714, and 716, the windows were darker on the two vertical edges and lighter in the center, the two vertical edges being where bus bars were located. Tint profile nonuniformity appeared in both windows during tint transitioning during these images 712, 714, and 716. Image 720 was taken at the beginning of a clearing pulse at 4:31 PM. At this time, both windows had similar tint states as in image 716, showing some edge to center nonuniformity. Image 722 was taken at 4:34 PM in the middle of the clearing pulse interval of voltage profile 704. The window on the left, using the voltage profile 704, had improved (i.e., increased) tint uniformity than it did earlier as shown in image 720 and as compared to the window on the right. The window on the right controlled by the conventional method continued to darken, still exhibiting significant edge to center nonuniformity. Image 724 was taken at the end of the clearing pulse and the beginning of the hold voltage of voltage profile 704 at 4:36 PM. The window on the left controlled by the disclosed method appeared more evenly tinted than in image 722. The window on the right controlled by the conventional method is further tinted than in image 722, while still exhibiting edge-to-center nonuniformity. It was also less tinted than the window on the left. Image 762 taken at 4:59 PM. Both windows on were in a steady state with target level. Images 720-724 show that the clearing pulse of voltage profile 704 improved uniformity of tint levels across the face of the switchable window. Image 724 shows that the disclosed method caused the switchable window to reach its target steady tint state before the conventional method.

### IV. TINT TRANSITION METHODS

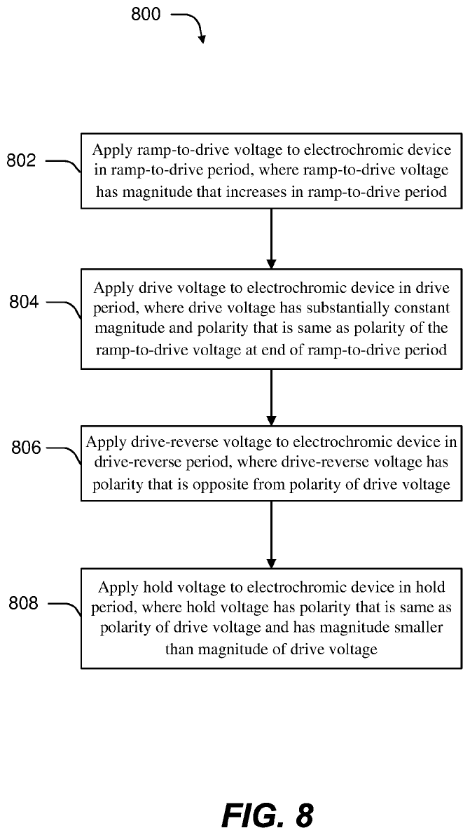

FIG. 8 shows a flowchart for a process 800 for controlling an electrochromic device according to some implementations. Process 800 includes operations 802, 804, 806, and 808 which, in some embodiments, may be performed in temporal order. Some implementations of process 800 include additional, optional operations as explained hereinafter. Some implementations include only these four operations. Other implementations consist essentially of these four operations.

Process 800 starts by applying the ramp-to-drive voltage to the electrochromic device in the ramp-to-drive period. See block 802. The ramp-to-drive voltage has a magnitude that increases in the ramp-to-drive period. In some implementations, the magnitude of the ramp-to-drive voltage increases in the ramp-to-drive period with a rate in the range of about 1 to 250 mV/s. In some implementations, the magnitude increases at a rate of about 250 mV per second. In some implementations, the magnitude increases at a rate that varies for different window sizes or BBDs. In some implementations, the magnitude increase rate is higher for larger windows or larger BBDs. In some implementations, process 800 controls the ECD to change from a clearer state to a more tinted state. In some implementations. the ramp-to-drive voltage of process 800 corresponds to ramp-to-drive voltage 510 of voltage profile 5002 in FIG. 5B and voltage profile 5003 in FIG. 5C, and the leading edge ramp voltage 5431 of voltage profile 5421 of FIG. 5D.

Process 800 further involves applying a drive voltage to the ECD in the drive period. See block 804. The drive voltage operation 804 in some implementations corresponds to drive voltage 512 of drive profile 5002 in FIG. 5B and voltage profile 5003 in FIG. 5C, and drive voltage 5427 of voltage profile 5421 of FIG. 5D. The drive voltage has a substantially constant magnitude and a polarity that is the same as a polarity of the of the ramp-to-drive voltage at the end of the ramp-to-drive period. In some implementations, the drive voltage has a magnitude that is substantially the same as a magnitude of the ramp-to-drive voltage at the end of the ramp-to-drive period. In some implementations, the drive voltage is set based on a burn-in voltage determined in a quality control process. The burn-in voltage is the voltage determined in a quality control testing process that does not cause undesirable defects during normal use or normal lifespan of the product. In some implementations, the burn-in voltage is the highest voltage determined to not cause such defects. In various applications and conditions, the burn-in voltage is about 4000, 5000, 6000, 7000, 8000, 9000, 10,000, 15,000, 18,000, 20,000, 30,000, or 40,000 mV. In some implementations, the drive voltage is at or near the burn-in voltage. In other implementations, the drive voltage is lower than the burn-in voltage, e.g., at about 50%, 60%, 70%, 80%, or 90% of the burn-in voltage.

The duration of the drive voltage may be adjusted for different tint states, with more tinted states requiring longer drive times. The duration of the drive voltage may also be adjusted for different window sizes, applying longer drive time to larger windows. The duration of the drive period may increase as the distance between two bus bars of windows increase.

In some implementations, the magnitude of the drive voltage is in a range of about −40,000 to 40,000 mV. In some implementations, the magnitude of the drive voltage is in a range of about −20,000 to 20,000 millivolts. In some implementations, the drive voltage is in a range of about −20,000 to 20,000 millivolts. In some implementations, the drive voltage is in a range of about −5,000 to 5,000 millivolts. In some implementations, the magnitude of the hold voltage is empirically determined by a burn-in voltage determined through burn-in testing process of the electrochromic stack in the ECD.

Process 800 further involves operation 806 of applying a drive-reserve voltage to the electrochromic device in a drive-reverse period. The drive-reverse voltage of operation 806 in some implementations corresponds to drive-reverse voltage 516 of voltage profile 5002 of FIG. 5B and voltage profile 5003 in FIG. 5C. In some implementations, the drive-reverse voltage has a polarity that is opposite from the polarity of the drive voltage, as illustrated in FIGS. 5B and 5C, for example. In other implementations, the drive-reverse voltage has the same polarity as the polarity of the drive voltage, but its magnitude is smaller than the magnitude of the drive voltage. In some implementations, the drive-reverse voltage has the magnitude in a range of about 1400 mV to 2600 mV. In some implementations, the duration of the drive-reverse voltage is adjusted for different window sizes. In some implementations, the duration of the drive-reverse voltage is adjusted for different drive voltages. In some implementations, the duration of the drive-reverse voltage is different for different target tint states. In some implementations, the drive-reverse voltage has a duration of about 30 to 300 seconds.

Some implementations include applying, after the drive period and before the drive-reverse period, a ramp-to-drive-reverse voltage to the electrochromic device in a ramp-to-drive-reverse period, in which the ramp-to-drive-reverse voltage changes from the drive voltage to the drive-reverse voltage in the ramp-to-drive-reverse period at a rate in a range of about 1 to 250 millivolts/second (mV/s). In some implementations, the polarity of the ramp-to-drive-reverse voltage changes during the ramp-to-drive-reverse voltage period. For example, as illustrated in FIGS. 5B and 5C, the ramp-to-drive-reverse voltage 514 changes at a particular rate from the drive voltage 512 in the drive period to the drive-reverse voltage 516 and also changes polarity during this period. Here in these examples, the polarity changes from negative to positive, with the drive voltage 512 being negative and the drive-reverse voltage 516 being positive; in some other embodiments, the polarity may change from positive to negative.

Process 800 further involves applying a hold voltage to the ECD in a hold period. See block 808. The hold voltage has a polarity that is the same as the drive voltage and a magnitude smaller than that of the drive voltage, such as both the hold voltage and the drive voltage having a negative polarity and, in some instances, the drive-reverse voltage having an opposite, positive polarity. The hold voltage may be adjusted for different target steady-state tint levels or different materials of the electrochromic stack of the ECD. The hold voltage may be similar to hold voltage used in conventional methods for keeping the ECD in the target steady-state tint level. In some implementations, the hold voltage of operation 808 corresponds to the hold voltage 520 of voltage profile 5002 in FIGS. 5B and 5C, and 5425 of FIG. 5D. In FIGS. 5B and 5C, for instance, both the drive voltage 512 and the hold voltage 520 have negative polarity and the drive-reverse voltage 516 has a positive polarity.

In some implementations, process 800 causes the electrochromic device to transition from a clearer state to a more tinted state. The electrochromic device has a higher optical density at the start of the hold period than at the start of the ramp-to-drive period. For example, see FIG. 6B showing different periods of voltage profile 5002 and corresponding optical density profile 6002 of the ECD; the OD is indicated on the right-side axis of the Figure. At the beginning of the ramp-to-drive period, the optical density of the ECD is at a level indicated by point 612 on the optical density profile 6002, which is lower than the optical density at the beginning of the hold period indicated by point 614 on optical density profile 6002. Namely, the disclosed tint transition process increases the optical density of the ECD at a target or hold state relative to the beginning state. In other implementations, however, a voltage profile that has inverse polarity as voltage profile 5002 may be used to change ECD from a more tinted state to a clearer state.

In some implementations, process 800 causes an optical density of one or more edges of the ECD at the start of the hold period to be higher than at the start of the drive period, and lower than at the end of the drive period. Each of the one or more edges of the ECD is proximal to an electrode, e.g., a bus bar, configured to apply a voltage to the ECD. For example, as explained above, FIG. 6B shows an optical density profile 6002 for an edge of an ECD. The voltage profile 5002 is applied to cause the ECD to transition its optical state. A clearing pulse including the drive reverse voltage 516 in the voltage profile 5002 causes the ECD to reduce its optical density at the edge, leading to improved edge-to-center uniformity. The optical density of the edge of the ECD at the beginning of the hold period as indicated by point 614 on optical density profile 6002 is higher than the optical density at the beginning of the drive period as indicated by point 616 on optical density profile 6002. Furthermore, the optical density of the edge of the ECD at the beginning of the hold period as indicated by point 614 on optical density profile 6002 is lower than the optical density at the end of the drive period as indicated by point 618 on optical density profile 6002. In other words, the drive voltage in the drive period drives the edge of the ECD to an optical density level above a target steady-state tint level, resulting in over tinting of the edge of the ECD. And then the drive-reverse voltage 516 in the drive-reverse period reverses the over tinting. Because the drive voltage at the drive period has a higher effective voltage at the two edges of the ECD than at the center as explained in connection to FIG. 1C, it darkens the edges more so than the center of the ECD, contributing to edge-to-center non-uniformity. Because the drive-reverse voltage 516 also has a higher effective voltage at the two edges of the ECD than at the center, it clears the edges more so than the center of the ECD, improving edge-to-center uniformity.

Returning to FIG. 8, process 800 in some implementations optionally involves applying a ramp-to-hold voltage to the ECD in the ramp-to-hold period, although this operation is not illustrated in FIG. 8 as it is optional. In some implementations, this ramp-to-hold voltage corresponds to the ramp-to-hold voltage 518 of voltage profile 5002 in FIGS. 5B and 5C, and 5433 of FIG. 5D. The ramp-to-hold period is after the drive-reverse period and the before the hold period. The ramp-to-hold voltage changes from the drive-reverse voltage to the hold voltage at a rate in a range of about 1 to 25 mV/s. In some implementations, the polarity of the ramp-to-hold voltage changes during the ramp-to-hold voltage period. For example, as seen in FIGS. 5B and 5C, the voltage changes from a positive polarity to a negative polarity during this period.

In some implementations, process 800 optionally further includes applying one or more hold-reverse voltages to the ECD after the hold period. Although this operation is not illustrated in FIG. 8 as it is optional, examples of the hold-reverse voltages are illustrated above in FIG. 5C. The one or more hold-reverse voltages have a polarity that is opposite from the polarity of the hold voltage. In other implementations, the hold-reverse voltages have the same polarity as the hold voltage, but smaller magnitudes than the hold voltage. In various implementations, the hold-reverse voltage is in a range of about −4000 to 2000 mV/s. In some implementations, the hold-reverse voltage is in a range of about −10,000 to 4,000 mV/s. In some implementations, the hold-reverse voltage is in a range of about −20,000 to 8,000 mV/s. In some implementations, each hold-reverse voltage is applied for about 2 to 10 minutes. In some implementations, the hold-reverse voltage of process 800 corresponds to hold-reverse voltage 524 of voltage profile 5003 in FIG. 5C.

In some implementations, process 800 optionally further includes applying a hold-forward voltage to the ECD after each hold-reverse voltage is applied. Although this operation is not illustrated in FIG. 8 as it is optional, examples of the hold-forward voltages are illustrated above in FIG. 5C. The one or more hold-forward voltages have a same polarity as the polarity of the hold voltage. In some implementations, the hold-forward voltages have a magnitude larger than the hold voltage. In some implementations, the hold-forward voltage is in a range of about −4000 to 2000 mV. In some implementations, the hold-forward voltage is in a range of about −10,000 to 4,000 mV/s. In some implementations, the hold-forward voltage is in a range of about −20,000 to 8,000 mV/s.

In some implementations, each hold-forward voltage is applied for about 2 to 10 minutes. In some implementations, each hold-forward voltage is applied for about 1 to 20 minutes. In some implementations, the hold-forward voltage of process 800 corresponds to hold-forward voltage 528 of voltage profile 5003 in FIG. 5C.

The hold-reverse voltages and the hold-forward voltages may be adjusted in their magnitude and/or duration depending on the relevant hold voltage. They may also be adjusted based on the materials and electrical properties of the electrochromic stack of the ECD.

In some implementations, process 800 optionally further includes applying a ramp-to-hold-reverse voltage immediately before applying each hold-reverse voltage. Although this operation is not illustrated in FIG. 8 as it is optional, examples of the ramp-to-hold-reverse voltage are illustrated above in FIG. 5C. In some implementations, the ramp-to-hold-reverse voltage changes at a rate in a range of about 10 to 250 mV/s until reaching the hold-reverse voltage. In some implementations, the ramp-to-hold-reverse voltage changes at a rate of about 50 mV/s until reaching the hold-reverse voltage. In some implementations, the ramp-to hold-reverse voltage corresponds to ramp-to-hold-reverse voltage 522 of voltage profile 5003 in FIG. 5C.

In some implementations process 800 further includes applying a ramp-to-hold-forward voltage after applying the hold-reverse voltage and a before applying the hold-forward voltage. Although this operation is not illustrated in FIG. 8 as it is optional, examples of the ramp-to-hold-forward voltage are illustrated above in FIG. 5C. The ramp-to-hold-forward voltage changes from the hold-reverse voltage to the hold-forward voltage at a rate in a range of about 10 to 250 mV/s. In some implementations, the ramp-to-hold-forward voltage of process 800 corresponds to ramp-to-hold-forward voltage 526 of voltage profile 5003 in FIG. 5C.

In various implementations, process 800 is applied to electrochromic devices that are larger than certain criteria, such as having a distance between bus bars (a bus-bar distance) larger than about 24, 36, 48, or 60 inches. This distance is also referred to as a distance between bus bars in this disclosure. See FIGS. 1D-1F illustrating an ECD and distance between its two bus bars; in some instances, this may be a perpendicular or substantially perpendicular distance between these bus bars.

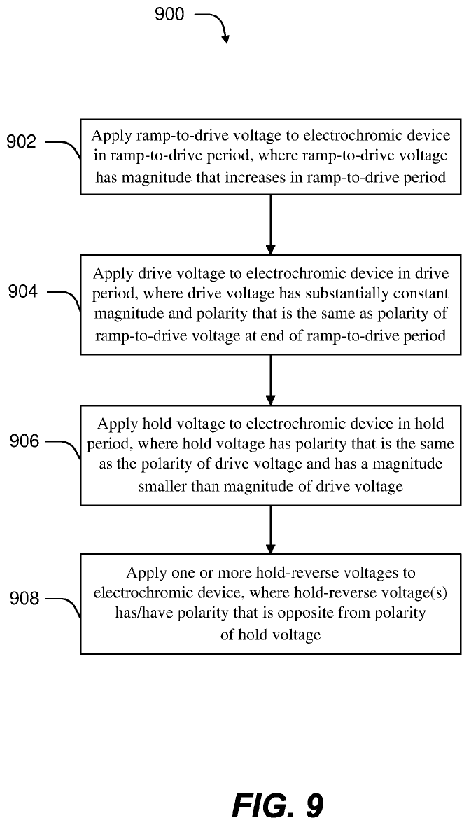

FIG. 9 shows a flowchart for a process 900 for controlling an electrochromic device in accordance with some disclosed embodiments. Some implementations of the process 900 use a voltage profile similar to voltage profile 5003 in FIG. 5C. In some implementations, the process includes only operations 902, 904, 906, and 908, performed in temporal order. In other implementations, additional operations are included as further explained below, but not illustrated in FIG. 9.

Process 900 starts by applying a ramp-to-drive voltage to the ECD in a ramp-to-drive period. See block 902. The ramp-to-drive voltage has a magnitude that increases in the ramp-to-drive period. In some implementations, the ramp-to-drive voltage increases at a rate of about 1 to 250 mV/s. In some implementations, the ramp-to-drive voltage of operation 902 corresponds to ramp-to-drive voltage 510 of voltage profile 5003 in FIG. 5C.

Process 900 further involves applying a drive voltage to the ECD in a drive period. See block 904. The drive voltage has a substantially constant magnitude and a polarity that is the same as a polarity of the of the ramp-to-drive voltage at the end of the ramp-to-drive period. In some implementations, the drive voltage has a magnitude that is substantially the same as a magnitude of the ramp-to-drive voltage at the end of the ramp-to-drive period. The magnitude of the drive voltage in some implementations is in the range of about −2200 mV to −4600 mV as explained above for operation 804. The drive voltage of operation 904 corresponds to drive voltage 512 of voltage profile 5003 in FIG. 5C. In some implementations, the drive voltage does not exceed a burn-in voltage.

Process 900 further includes applying a hold voltage to the ECD in a hold period. See block 906. The hold voltage has a polarity that is the same as the polarity of the drive voltage. The hold voltage has a magnitude smaller than the attitude of the drive voltage. The hold voltage of operation 906 corresponds to hold voltage 520 of voltage profile 5003 in FIG. 5C. In some implementations, process 900 causes the ECD to have a higher optical density at the start of the hold period than at the start of the ramp-to-drive period.

Process 900 further includes applying one or more hold-reverse voltages to the ECD after the hold period. See block 908. The one or more hold-reverse voltages of operation 902 correspond to hold-reverse voltage 524 of voltage profile 5003 in FIG. 5C. In some implementations, the one or more hold-reverse voltages have a polarity that is opposite from the polarity of the hold voltage. In other implementations, the hold-reverse voltages have a same polarity as the hold voltage but are smaller magnitude. In some implementations, the hold-reverse voltage has a magnitude in a range of about −4,000 to 2,000 mV. In some implementations, the hold-reverse voltage has a magnitude in a range of about −10,000 to 4,000 mV. In some implementations, the hold-reverse voltage has a magnitude in a range of about −20,000 to 8,000 mV. In some implementations, each hold-reverse voltage is applied for about 2 to 10 minutes. In some implementations, each hold-reverse voltage is applied for about 1 to 20 minutes. As explained above, the magnitude and duration of the hold-reverse voltages may be adjusted for different hold voltages and/or various target tint states.

In some implementations not illustrated in FIG. 9, process 900 optionally further includes applying a hold-forward voltage to the ECD after each hold-reverse voltage is applied. The hold-forward voltage corresponds to hold-forward voltage 528 of voltage profile 5003 in FIG. 5C. The one or more hold-forward voltages have a same polarity as the polarity of the hold voltage. In some implementations, the one or more hold-forward voltages have a magnitude larger than the magnitude of the hold voltage. In some implementations, the hold-forward voltage is in the range of about −4,000 to 2,000 mV/s. In some implementations, the hold-forward voltage is in the range of about −8,000 to 4,000 mV/s. In some implementations, the hold-forward voltage is in the range of about −20,000 to 8,000 mV/s. In some implementations, each hold-forward voltage is applied for about 2-10 minutes. In some implementations, each hold-forward voltage is applied for about 1-20 minutes. In various applications, the hold-forward voltage may be adjusted for different hold voltages and/or various target tint states.

In some implementations not illustrated in FIG. 9, process 900 optionally further includes applying a ramp-to-hold-reverse voltage immediately before applying each hold-reverse voltage. The ramp-to-hold-reverse voltage corresponds to ramp-to-hold-reverse voltage 522 of voltage profile 5003 in FIG. 5C. The ramp-to-hold-reverse voltage changes at a rate in a range of about 10 to 250 mV until reaching the hold-reverse voltage. In some implementations, the ramp-to-hold-reverse voltage changes at a rate of about 50 mV/s until reaching the hold-reverse voltage.

In some implementations not illustrated in FIG. 9, process 900 optionally further includes applying a ramp-to-hold-forward voltage after applying a hold-reverse voltage and before applying a hold-forward voltage. The ramp-to-hold-forward voltage corresponds to ramp-to-hold-forward voltage 526 of voltage profile 5003 in FIG. 5C. The ramp-to-hold- forward voltage changes from the hold-reverse voltage to the hold-forward voltage at a rate in a range of about hand in a range of about 10 to 250 mV until reaching the hold-reverse voltage. In some implementations, the ramp-to-hold-reverse voltage changes at a rate of about 50 mV/s until reaching the hold-reverse voltage.

In some implementations not illustrated in FIG. 9, process 900 optionally further includes applying a ramp-to-hold voltage to the ECD in a ramp-to-hold period. The ramp-to-hold period is after the drive period and before the hold period. The ramp-to-hold voltage corresponds to ramp-to-hold voltage 518 of voltage profile 5003 in FIG. 5C. The ramp-to-hold voltage changes in the ramp-to-hold period at a rate in a range of about 10 to 250 mV until reaching the hold voltage. In some implementations, the ramp-to-hold voltage changes at a rate of about 50 mV/s until reaching the hold voltage.

In various implementations, process 900 applies to windows larger than certain sizes. In various implementations the windows have a bus-bar distance of least about 24, 36, 48, or 60 inches.

### V. EXAMPLES

Various example implementations, techniques and data will now be discussed. The ECDs in the examples herein have four tint states labeled as T1, T2, T3, and T4, going from the clearest state to the most tinted state.

### Example 1

Example 1 shows tint state data of windows of different sizes controlled by a method according to some implementations of the disclosure. Data of Example 1 are presented in FIGS. 10-13. The tint data of the windows compare the optical density of the center of the window and two edges of the window where two bus bars are located. One of the edges is where a bus bar contacts an ITO TCO layer, which edge is referred to as the ITO edge. Another edge is where the bus bar contacts an TEC TCO later, which edge is referred to as the TEC edge.

The ECDs in this example have four tint states labeled as T1, T2, T3, and T4. In this example, T1 has an optical density (or absorbance) of 0.3 and a transmittance of 50%. T2 has an optical density of 0.52 and a transmittance of 30%. T3 has an optical density of 1.22 and a transmittance of 6%. T4 has an optical density of 2.3 and a transmittance 0.5%. In some cases, T4 has an optical density of 2.0 and a transmittance 1%.

FIG. 10 shows optical density data during a tint transition from T1 to T4 for an ECD having a bus bar distance of 59 inches. The method employed a voltage profile 1000 having a form shown in the top half of FIG. 10, which is similar to voltage profile 5002 in FIG. 5B. The top half of the figure shows the optical density of the TEC edge, the ITO edge, and the center of the ECD. The bottom half of the figure shows the difference of optical density between the TEC edge and the center (labeled “TEC” in the Figure) and the difference between the ITO edge and the center (labeled “ITO” in the Figure). As can be seen in the top half of the figure, the optical densities of the TEC edge, ITO edge and center increased when the drive voltage was applied. At the end of the drive period (1002), they reached optical density levels that were higher than at the beginning of the hold voltage. The TEC edge had the highest optical density, followed by the ITO edge, followed by the center. This is consistent with images 712, 714, 716 in FIG. 7, where the window on the left half of each image transitioned from a lighter to a darker state, and the center was lighter than the two vertical edges. The window on the left half of the images in FIG. 7 was controlled by voltage profile 704 similar to profile 1000 of FIG. 10.

When a drive-reverse voltage 1012 (clearing voltage) was applied (which drive-reverse voltage 1012 corresponds to, e.g., the drive-reverse voltage 516 in FIGS. 5B, 5C, and 6B), optical densities of the TEC edge, the ITO edge and the center all decreased. These optical densities were all different from each other during the drive period. However, they all quickly converged during the drive-reverse period, leading to improved edge-to-center OD uniformity, which is desirable by users. The ITO edge optical density decreased faster than that of the center. The ITO optical density temporal profile in the top half of the figure also crossed over the profile of the center at time 1004, which is also seen in the bottom half of the figure as a zero crossing of the ITO Delta OD profile (difference between the ITO edge and the center). Time 1004 was the time when the ITO edge and the center were identical in OD, and it occurred when the drive-reverse voltage is applied during the drive-reverse period. At time 1006, the OD profile of the TEC average crossed over the profile of the center of the ECD in the top half of the figure. This is also seen as a zero crossing of the TEC Delta OD profile (difference between the TEC edge and the center) in the bottom half of the figure. Time 1006 was the time when the ITO edge and the center were identical in OD, and it occurred when the drive-reverse voltage is applied during the drive-reverse period. During the clearing voltage, the OD differences between the edges and the center decreased. When a hold voltage is applied, as seen in the top half of the figure, optical densities approached the target optical density T4 (indicated by dash line 1010). The Delta OD profiles for the TEC edge and the ITO edge in the bottom half of FIG. 10 illustrate that during the drive interval the TEC edge was significantly more tinted than the center. The ITO edge was also darker than the center but to a lesser extent during the drive period. The clearing pulse in the voltage profile helps to bring down the difference between the edges and the center to zero and then slightly negative; this clearing pulse therefore reduces nonuniformity between each edge and the center of the window which provides for a more uniform looking window across its width. The differences remain relatively small in the hold period, such as at time 1008.

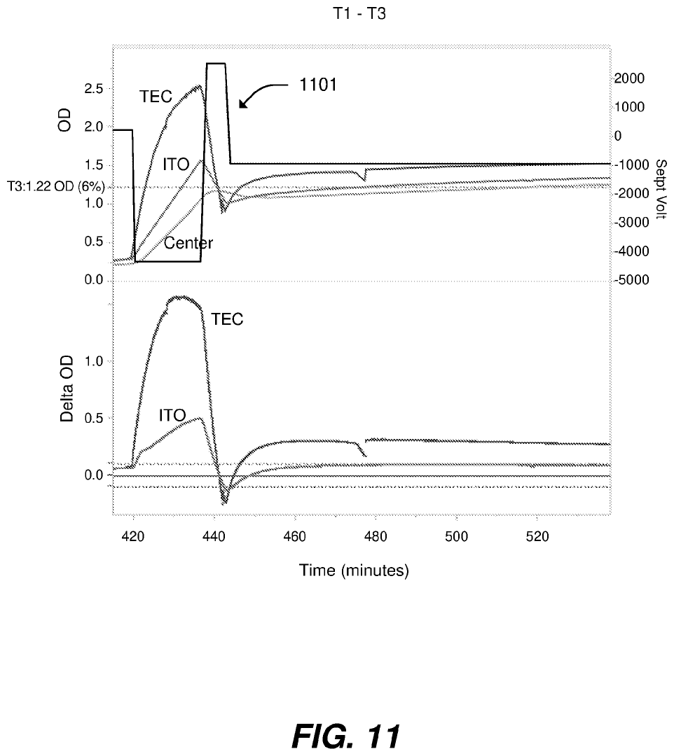

FIG. 11 shows similar data of the same ECD as FIG. 10. FIG. 11 shows a tint

transitioning process from T1 to T3, whereas FIG. 10 shows a process transitioning from T1 to T4. The method applies voltage profile 1101 which is similar to the voltage profile of FIG. 5B. The optical density profiles in FIG. 11 have similar shapes and patterns as those in FIG. 10. The drive period was shorter in FIG. 11 than FIG. 10, because it took a shorter time to change the tint of the ECD from T1 to T3. As can be seen in the top half of the figure, the drive voltage quickly increased the OD of the edges and the center of the ECD to the target OD of 1.22. The Delta OD profiles for the TEC edge and the ITO edge in the bottom half of FIG. 11 illustrate that during the drive interval the TEC edge was significantly more tinted than the center. The ITO edge was also darker than the center but to a lesser extent during the drive period. The clearing pulse in the voltage profile helps to bring down the difference between the edges and the center to near zero. The tint methods here still effectively reduce nonuniformity going to from T1 to T3.

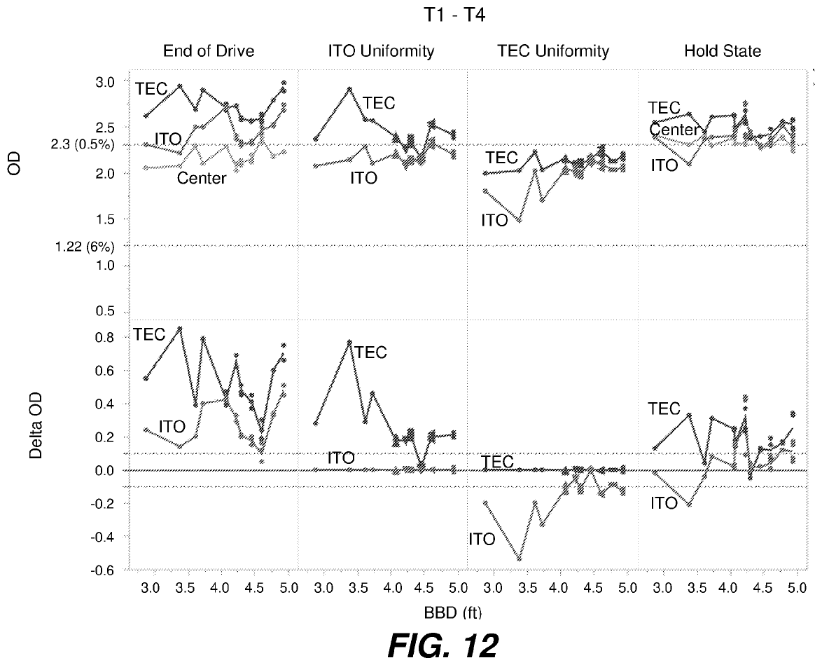

FIG. 12 shows optical density for ECDs of various sizes at four different stages of a tint transition process from T1 to T4. The horizontal axis is the separation distance between bus bars that are parallel, or substantially parallel to each other, in feet, or bus bar distance (BBD). The vertical axis indicates OD or Delta OD as explained above. Each subpanel of FIG. 12 includes data for ECDs having different sizes. The ECDs ranged from 2.5 feet to 5 feet as measured by bus bar distance. The figure includes four columns for the four different stages of the tint transition process. The first stage is the end of drive stage shown in the first column from the left in FIG. 12. This stage corresponds to time point 1002 in FIG. 10. The second stage of the tint transition process is the ITO uniformity stage shown in the second column from the left in FIG. 12. This stage corresponds to time point 1004 in FIG. 10, which is when the ITO edge and the center had the same OD. At this point of time, the ITO OD profile crossed the center OD profile in the top half of FIG. 10. The third stage of the tint transition process is the TEC uniformity stage shown in the third column from the left in FIG. 12. This stage corresponds to time point 1006 in FIG. 10, which is when the TEC edge and the center had the same OD. At this time, the TEC OD profile crossed the center OD profile in the top half of FIG. 10. The fourth stage of the tint transition process is the hold stage shown in the fourth column from the left in FIG. 12. This stage corresponds to time point 1008 in FIG. 10. The top half of FIG. 12 shows the optical density of the TEC edge, the ITO edge, and the center. The bottom half of FIG. 12 shows the difference of optical density between the TEC edge and the center, as well as the difference between the ITO edge and the center.

As seen in the top half of FIG. 12, the TEC edges and the ITO edges of ECDs of various sizes had optical densities above the target optical density of 2.3 (0.5 transmittance) at the end of drive stage and the centers of the ECDs were near, or slightly below the target OD. At ITO uniformity, the ITO edges and the centers overlapped in OD and were near or below the target OD, while the TEC edges were above or near the target OD. At TEC uniformity, ODs of the TEC edges and the centers overlapped and were near or slightly below the target OD. The ITO optical densities were lower than the TEC optical densities. These stages show the temporal OD dynamics of the edges and center of the ECD before they approach the target OD. During hold state, the TEC edges, the centers and the ITO edges were all close to target OD, which indicates that the methods achieve uniform OD across the ECD in the hold state.

The bottom half of FIG. 12 shows edge-to-center OD differences, or delta ODs. At the end of drive stage, delta ODs were relatively large. They were generally larger for the TEC edges than for the ITO edges. At the ITO uniformity stage, the optical density of the ITO edges and the centers overlapped. The differences between the TEC edges and the centers were positive (the TEC edges being darker) and relatively large, and especially for the smaller windows. At the TEC uniformity stage, optical densities of the TEC edges and centers overlapped. The differences between the ITO edges and the centers were negative, with the ITO edges being lighter than the centers. These stages show the OD temporal dynamics of the edges and the center of each ECD before reaching the target OD. At hold state, the differences between the edges and the centers became markedly smaller than at end of drive, indicating that the drive-reverse voltage or clearing pulse applied in the disclosed methods improved the uniformity of tinting of the ECDs. Windows with smaller BBDs tend to have larger differences between the ITO and TEC edges than windows with larger BBDs in the first three stages of transition. However, the methods achieve OD uniformity during hold stage across all window sizes.

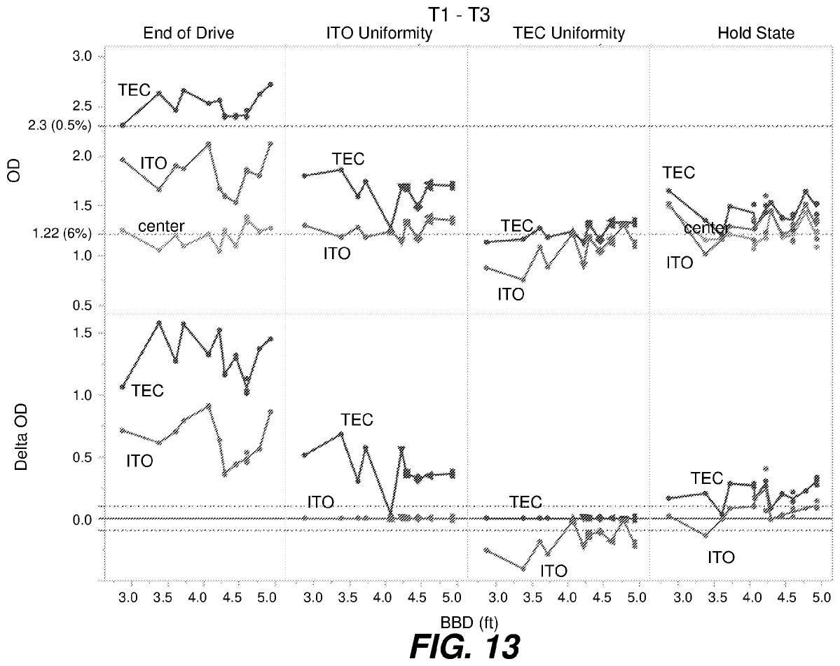

FIG. 13 shows data obtained from a tinting process that changed tint states of the ECDs from T1 to T3. The data in FIG. 13 have generally the same patterns as in FIG. 12. However, the Delta OD values for the TEC and ITO edges shrunk more significantly from end of drive to hold state in FIG. 13 than in FIG. 12. This indicates that there was a larger degree of edge-to-center nonuniformity in the tint transition process from T1 to T3 than in the tint transition process from T1 to T4. Nevertheless, the disclosed methods can achieve OD uniformity in both transition processes. It appears that the effectiveness of the methods persist across different window sizes.

### Example 2

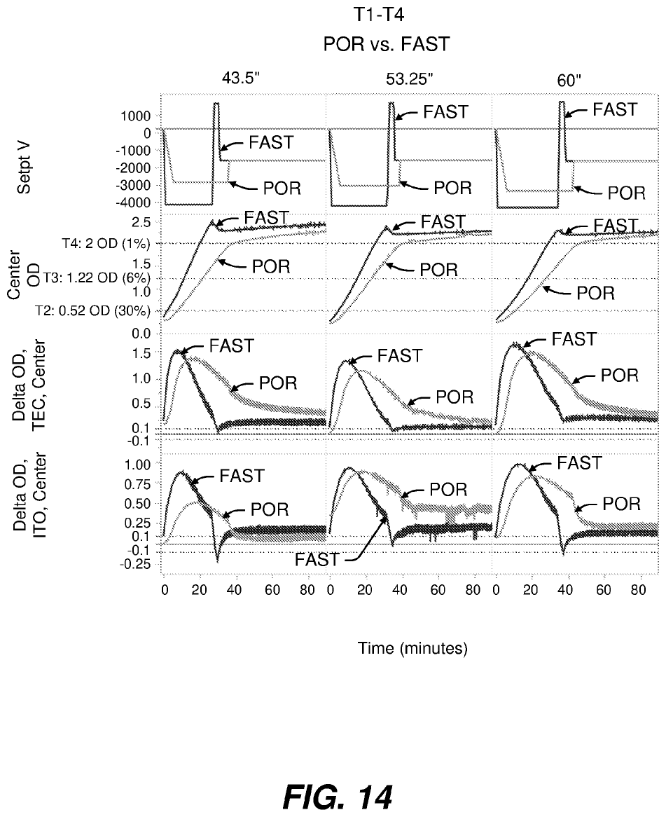

This example shows that some methods according to some implementations provide various advantages over conventional methods as explained above. The example compares tinting performance between methods according to some implementations and a conventional method. Data of Example 2 are presented in FIGS. 14-17. The switchable windows or ECDs in this example also had four tint states similar to the four tint states in Example 1, except that the most tinted level, T4, of this example had an optical density of 2 or transmittance of 1%. FIG. 14 shows data for a tint transition from T1 to T4. The left column shows data for two windows of a bus bar distance of about 48.5 inches. The middle column shows data for two windows of a bus bar distance about 53.25 inches. The right column shows data for two windows of a bus bar distance of about 60 inches. One window of each size is controlled by a method according to some implementations, data of which window are labeled as FAST. The other window of each size is controlled by a conventional method, data of which are labeled as POR, short for Process of Record.

The top row of FIG. 14 shows voltage profile FAST and voltage profile POR, which are respectively similar to profiles 5002 and 5001 in FIG. 5B; profile 5001 is also shown in FIG. 5A. The second row shows OD profiles of the center of each of the windows. The third row shows Delta OD profiles for the TEC edges. The bottom row shows the Delta OD profiles for the ITO edges. As seen in the second row, the disclosed method caused the ECD to increase its optical density more quickly than the conventional method, and reached the target OD of 2 (transmittance 1%) before the conventional method. This is advantageous because it is often desirable to have a window switch OD quickly once a command to switch is issued. This advantage is observed for windows of all three sizes: 48.5 inches, 53.25 inches, and 60 inches. As seen in the third row, the disclosed FAST method caused relatively large differences of OD between the TEC edges and the centers during the drive interval, but the differences were reduced to near zero by the clearing pulse (hold-reverse voltage), which differences during the hold period are smaller than those resulting from the conventional POR method. This advantage of the FAST method over the POR method persists for windows of all three sizes. This indicates that the clearing pulse (hold-reverse voltage) effectively reduced TEC-center tint nonuniformity for windows of various sizes. As shown in the fourth row, a similar data pattern is also seen for the ITO edge. The FAST method achieved near zero ITO-center OD difference for all three windows.

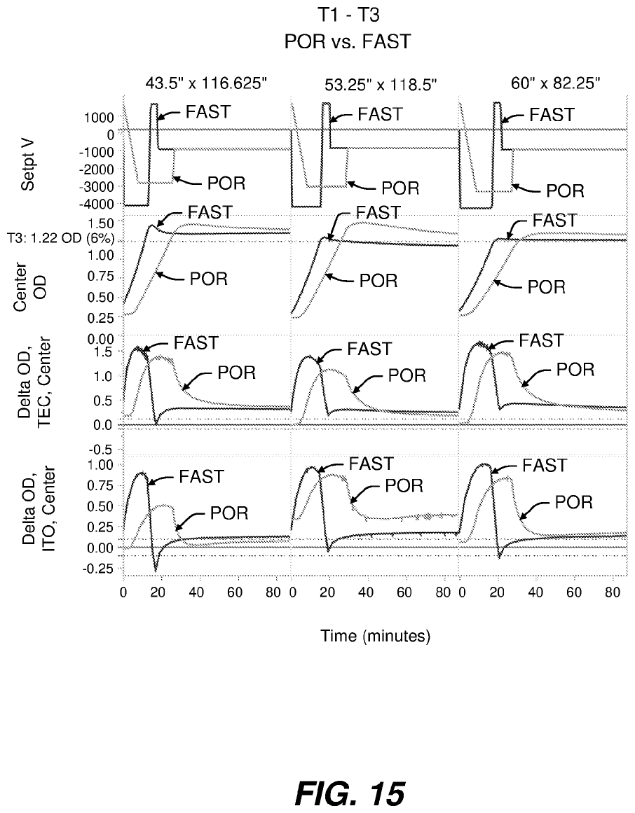

FIG. 15 shows data for a tint transition process that changed ECD tint levels from T1 to T3. The data patterns in FIG. 15 are generally consistent with those in FIG. 14, demonstrating that the disclosed method sped up tinting transition and improved tint uniformity for a tint transition from T1 to T3, as well as for a tint transition from T1 to T4. As seen in the second row, the disclosed FAST method caused the ECD to increase its optical density more quickly than the conventional method, and reached the target OD of 1.22 (transmittance 6%) much faster the conventional method. This advantage is observed for windows of all three sizes. Moreover, as seen in the third row, the FAST method effectively reduced TEC-center OD difference to near zero for windows of all sizes. And as seen in the fourth row, the FAST method effectively reduced ITO-center OD difference to near zero for windows of all sizes.

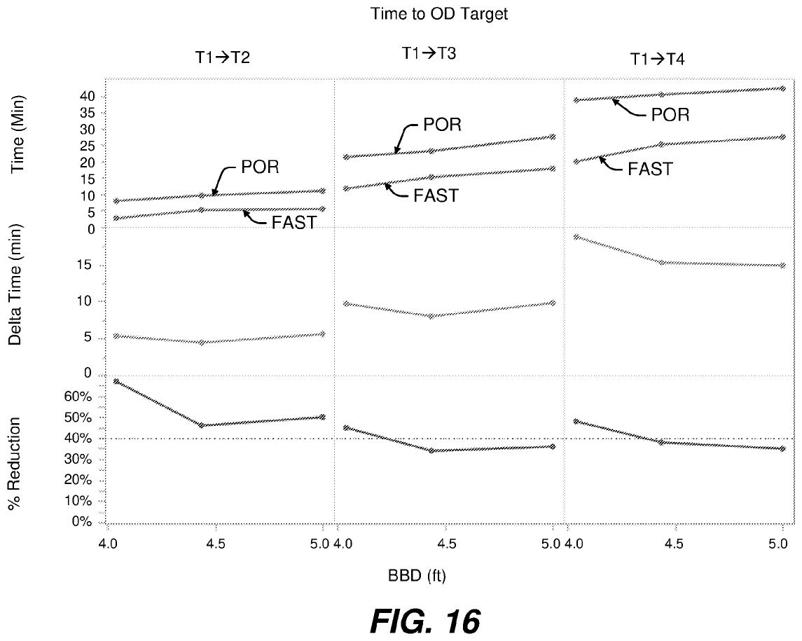

FIG. 16 shows data comparing the time to reach steady state optical density target between the disclosed method according to some implementations and a conventional method. The left column of FIG. 16 shows data for a tint transition from T1 to T2. The middle column shows data for a tint transition from T1 to T3. The right column shows data for a tint transition from T1 to T4. Each column includes data for two sets of windows, one set controlled by the POR method and another set by a FAST method according to some implementations. Each set of windows includes three (3) windows having BBDs of 4.0, 4.5, and 5.0 feet. The top row of FIG. 16 shows the time it took the processes to reach the optical density target, namely, the tint state of T2 for the left column, the tint state of T3 for the middle column, and the tint state of T4 for the right column. The middle row shows the differences of times between the two methods to reach the optical density target. The bottom row shows percentages of time reduction. Across the three window sizes and for all three tint transitions, the disclosed method is faster than the conventional method as seen in the top row of the figure. The middle row of the figure shows that the disclosed method was about five minutes faster for transitioning from T1 to T2. For transitioning from T1 to T3, the disclosed method was faster by about 10 minutes. For transitioning from T1 to T4, the disclosed method was faster by about 15 minutes. As seen in the bottom row of FIG. 16, the disclosed method reduced the time to reach target optical density by about 45% to 65% when transitioning from T1 to T2. When transitioning from T1 to T3 and from T1 to T4, the disclosed method reduced the time to reach OD target by about 40%.

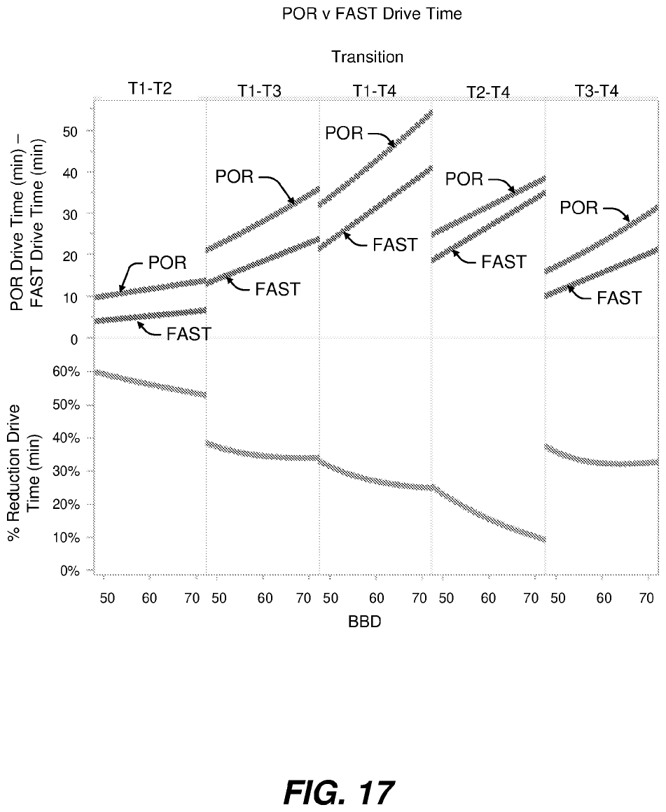

FIG. 17 compares the drive time between the disclosed method and the conventional method, the drive time being the time duration of the drive voltage during the drive period as explained above, e.g., with reference to FIGS. 5A-5D. The five columns from left to right show data for tint transition processes from T1 to T2, from T1 to T3, from T1 to T4, from T2 to T4, and from T3 to T4. The top half of the figure shows the drive time and the bottom half of the figure shows the percent reduction of drive time. Each subplot of figure includes data for windows between 50 inches and 70 inches. As seen in the top half of the figure, the disclosed methods took less time to drive the ECD than the conventional method in every transition process and for every window size. The bottom half of the figure shows that the disclosed method provides the largest percent reduction in drive time for transitioning from T1 to T2 and the smallest percent reduction for transitioning from T2 to T4. In terms of absolute time differences between the two methods, as seen in the top half of the figure, tint transitioning from T1 to T3 and from T1 to T4 had the largest separation in drivetime between the two methods.

In summary, the results of Example 2 show that the disclosed method sped up tint transition, leading to shorter drive period and shorter time to reach optical target optical density. Moreover, the disclosed method improved tint uniformity of the ECD by applying a clearing pulse before reaching a steady-state target optical density.

### Example 3

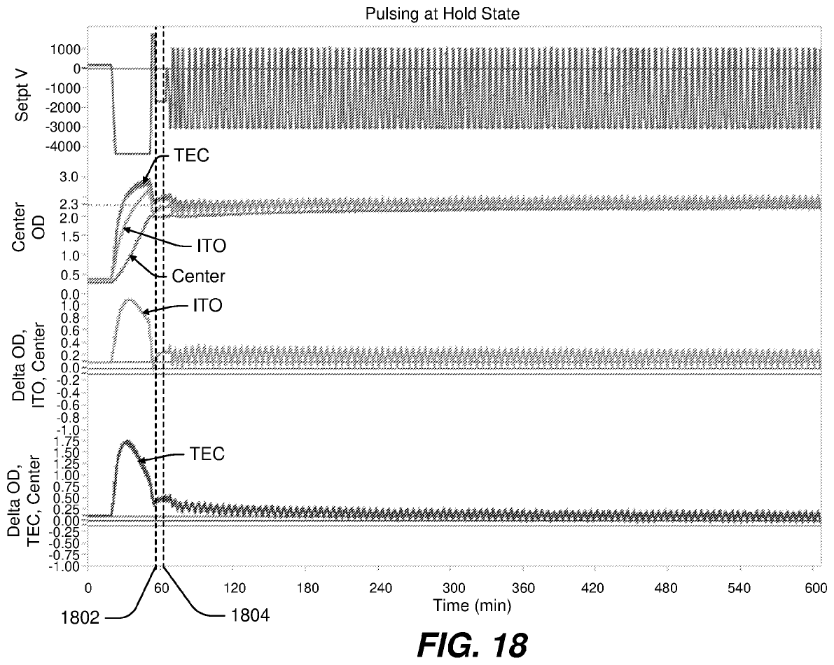

Data of Example 3 is presented in FIG. 18. FIG. 18 shows data of a method according to some implementations aimed to improve tint uniformity after the ECD has entered into a steady-state target optical density. The method applied a voltage profile that is shown in the top row of FIG. 18. The voltage profile is analogous to voltage profile 5003 in FIG. 5C. The second row of the figure shows the optical density profile of the TEC edge, the ITO edge, and the center of the ECD. The third row of FIG. 18 shows delta OD profile for the ITO edge, namely the difference of optical density between the ITO edge and center of the ECD. The bottom row shows the delta OD profile for the TEC edge, namely the difference of optical density between the TEC edge and center of the ECD.

At time 1802, after a clearing pulse is applied, ITO delta OD was reduced significantly to near zero as shown in the third row of the figure. The delta OD of the TEC edge shown in the bottom row was also reduced significantly. After time 1802 and when a hold voltage was applied, delta OD for both the ITO edge and TEC edge gradually increased. After time 1804, multiple hold pulses were applied. Each hold pulse changes between a hold-reverse voltage and a hold-forward voltage. These hold pulses caused the delta OD to oscillate for both the ITO edge and the TEC edge, moving them closer to zero. Therefore, in some such implementations, the hold pulses reduced edge to center nonuniformity after time 1804.

The term “system” may encompass all kinds of apparatuses, devices, and machines for processing data, including, for the purpose of illustration rather than limitation, a programmable processor, a computer, or multiple processors or computers. A processing system may include special purpose logic circuitry, e.g., an FPGA (field programmable gate array) or an ASIC (application specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, an engine, a pipeline, a module, a software module, a script, or code) can be written in any form of programming language, including compiled or interpreted languages, or declarative or procedural languages, and it can be deployed in any form, including as a stand-alone program or as a module, component, sub-routine, or other unit suitable for use in a computing environment. A computer program may, but need not, correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may also be deployed to be executed on a single computer or on multiple computers that, for example, are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from and/or transfer data to, one or more mass storage devices for storing data, e.g., magnetic, magneto-optical disks, or optical disks. However, a computer need not have such devices. Moreover, a computer may be embedded in another device, e.g., a mobile or cellular telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification may be implemented on a computer having a display device, e.g., a CRT (cathode ray tube) or LCD (liquid crystal display) monitor, for displaying information to the user, as well as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending Web pages to a Web browser on a user's user device in response to requests received from the Web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

Although this specification contains many specific implementation details, these details should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

Terms such as “a”, “an” and “the” are not intended to refer to only a singular entity but include the general class of which a specific example may be used for illustration. The terminology herein is used to describe specific embodiments, but their usage does not delimit.

When ranges are mentioned, the ranges are meant to be inclusive, unless otherwise specified. For example, a range between value 1 and value 2 is meant to be inclusive and include value 1 and value 2. The inclusive range will span any value from about value 1 to about value 2. The term “adjacent” or “adjacent to,” as used herein, includes next to,” “adjoining,” “in contact with,” and “in proximity to.”

As used herein, including in the claims, the conjunction “and/or” in a phrase such as “including X, Y, and/or Z”, refers to in inclusion of any combination or plurality of X, Y, and Z. For example, such phrase is meant to include X. For example, such phrase is meant to include Y. For example, such phrase is meant to include Z. For example, such phrase is meant to include X and Y. For example, such phrase is meant to include X and Z. For example, such phrase is meant to include Y and Z. For example, such phrase is meant to include a plurality of Xs. For example, such phrase is meant to include a plurality of Ys. For example, such phrase is meant to include a plurality of Zs. For example, such phrase is meant to include a plurality of Xs and a plurality of Ys. For example, such phrase is meant to include a plurality of Xs and a plurality of Zs. For example, such phrase is meant to include a plurality of Ys and a plurality of Zs. For example, such phrase is meant to include a plurality of Xs and Y. For example, such phrase is meant to include a plurality of Xs and Z. For example, such phrase is meant to include a plurality of Ys and Z. For example, such phrase is meant to include X and a plurality of Ys. For example, such phrase is meant to include X and a plurality of Zs. For example, such phrase is meant to include Y and a plurality of Zs. The conjunction “and/or” is meant to have the same effect as the phrase “X, Y, Z, or any combination or plurality thereof.” The conjunction “and/or” is meant to have the same effect as the phrase “one or more X, Y, Z, or any combination thereof.”

The term “operatively coupled” or “operatively connected” refers to a first element (e.g., mechanism) that is coupled (e.g., connected) to a second element, to allow the intended operation of the second and/or first element. The coupling may comprise physical or non-physical coupling (e.g., communicative coupling). The non-physical coupling may comprise signal-induced coupling (e.g., wireless coupling). Coupled can include physical coupling (e.g., physically connected), or non-physical coupling (e.g., via wireless communication). Operatively coupled may comprise communicatively coupled.

An element (e.g., mechanism) that is “configured to” perform a function includes a structural feature that causes the element to perform this function. A structural feature may include an electrical feature, such as a circuitry or a circuit element. A structural feature may include an actuator. A structural feature may include a circuitry (e.g., comprising electrical or optical circuitry). Electrical circuitry may comprise one or more wires. The electrical circuitry may be configured to coupe to an electrical power source (e.g., to the electrical grid). For example, the electrical circuitry may comprise a socket. Optical circuitry may comprise at least one optical element (e.g., beam splitter, mirror, lens and/or optical fiber). A structural feature may include a mechanical feature. A mechanical feature may comprise a latch, a spring, a closure, a hinge, a chassis, a support, a fastener, or a cantilever, and so forth. Performing the function may comprise utilizing a logical feature. A logical feature may include programming instructions. Programming instructions may be executable by at least one processor. Programming instructions may be stored or encoded on a medium accessible by one or more processors. Additionally, in the following description, the phrases “operable to,” “adapted to,” “configured to,” “designed to,” “programmed to,” or “capable of” may be used interchangeably where appropriate.

Modifications, additions, or omissions may be made to any of the above-described implementations without departing from the scope of the disclosure. Any of the implementations described above may include more, fewer, or other features without departing from the scope of the disclosure. Additionally, the steps of described features may be performed in any suitable order without departing from the scope of the disclosure. Also, one or more features from any implementation may be combined with one or more features of any other implementation without departing from the scope of the disclosure. The components of any implementation may be integrated or separated according to particular needs without departing from the scope of the disclosure.

It should be understood that certain aspects described above can be implemented in the form of logic using computer software in a modular or integrated manner. Based on the disclosure and teachings provided herein, a person of ordinary skill in the art will know and appreciate other ways and/or methods to implement the aspects using hardware and a combination of hardware and software.

Any of the software components or functions described in this application, may be implemented as software code using any suitable computer language and/or computational software such as, for example, Java, C, C #, C++ or Python, LabVIEW, Mathematica, or other suitable language/computational software, including low level code, including code written for field programmable gate arrays, for example in VHDL. The code may include software libraries for functions like data acquisition and control, motion control, image acquisition and display, etc. Some or all of the code may also run on a personal computer, single board computer, embedded controller, microcontroller, digital signal processor, field programmable gate array and/or any combination thereof or any similar computation device and/or logic device(s). The software code may be stored as a series of instructions, or commands on a CRM such as a random access memory (RAM), a read only memory (ROM), a magnetic medium such as a hard-drive or a floppy disk, or an optical medium such as a CD-ROM, or solid stage storage such as a solid state hard drive or removable flash memory device or any suitable storage device. Any such CRM may reside on or within a single computational apparatus, and may be present on or within different computational apparatuses within a system or network. Although the foregoing disclosed implementations have been described in some detail to facilitate understanding, the described implementations are to be considered illustrative and not limiting. It will be apparent to one of ordinary skill in the art that certain changes and modifications can be practiced within the scope of the appended claims.

The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has” or “includes” one or more steps is not limited to possessing only those one or more steps and can also cover other unlisted steps. Similarly, any composition or device that “comprises,” “has” or “includes” one or more features is not limited to possessing only those one or more features and can cover other unlisted features.

All methods described herein can be performed in any suitable order unless otherwise indicated herein or otherwise clearly contradicted by context. The use of any and all examples, or exemplary language (e.g. “such as”) provided with respect to certain implementations herein is intended merely to better illuminate the present disclosure and does not pose a limitation on the scope of the present disclosure otherwise claimed. No language in the specification should be construed as indicating any non-claimed element essential to the practice of the present disclosure.

Groupings of alternative elements or implementations of the present disclosure disclosed herein are not to be construed as limitations. Each group member can be referred to and claimed individually or in any combination with other members of the group or other elements found herein. One or more members of a group can be included in, or deleted from, a group for reasons of convenience or patentability. When any such inclusion or deletion occurs, the specification is herein deemed to contain the group as modified thus fulfilling the written description of all Markush groups used in the appended claims.

1. A method of controlling optical states of an electrochromic device, comprising:
applying a ramp-to-drive voltage to the electrochromic device in a ramp-to-drive period, wherein the ramp-to-drive voltage has a magnitude that increases in the ramp-to-drive period;
applying, after the ramp-to-drive period, a drive voltage to the electrochromic device in a drive period, wherein the drive voltage has a substantially constant magnitude and a polarity that is the same as a polarity of the ramp-to-drive voltage at end of the ramp-to-drive period;
applying, after the drive period, a drive-reverse voltage to the electrochromic device in a drive-reverse period, wherein the drive-reverse voltage has a polarity that is opposite from the polarity of the drive voltage; and
applying, after the drive-reverse period, a hold voltage to the electrochromic device in a hold period, wherein the hold voltage has a polarity that is the same as the polarity of the drive voltage and has a magnitude smaller than the magnitude of the drive voltage.

2. The method of claim 1, wherein the electrochromic device has a higher optical density at start of the hold period than at start of the ramp-to-drive period.

3. The method of claim 1, wherein the drive voltage has a magnitude that is substantially the same as a magnitude of the ramp-to-drive voltage at end of the ramp-to-drive period.

4. The method of claim 1, wherein the ramp-to-drive voltage has a magnitude that increases in the ramp-to-drive period at a rate in a range of about 1 to 250 millivolts/second (mV/s).

5. The method of claim 1, wherein the drive-reverse voltage has (i) a magnitude of about 1400 to 1900 millivolts and/or (ii) a duration in range between about 30 seconds and about 300 seconds.

6. (canceled)

7. The method of claim 1, wherein:
at start of the hold period, one or more edges of the electrochromic device have an optical density that is higher than at start of the drive period and lower than at end of the drive period, and
each of the one or more edges of the electrochromic device is proximal to a bus bar configured to apply a voltage to the electrochromic device.

8. The method of claim 1, further comprising applying, after the drive-reverse period and before the hold period, a ramp-to-hold voltage to the electrochromic device in a ramp-to-hold period, wherein the ramp-to-hold voltage changes from the drive-reverse voltage to the hold voltage in the ramp-to-hold period at a rate in a range of about 1 to 250 millivolts/second (mV/s).

9. The method of claim 8, wherein the polarity of the ramp-to-hold voltage changes during the ramp-to-hold voltage period.

10. The method of claim 1, further comprising applying, after the drive period and before the drive-reverse period, a ramp-to-drive-reverse voltage to the electrochromic device in a ramp-to-drive-reverse period, wherein the ramp-to-drive-reverse voltage changes from the drive voltage to the drive-reverse voltage in the ramp-to-drive-reverse period at a rate in a range of about 1 to 250 millivolts/second (mV/s).

11. The method of claim 10, wherein the polarity of the ramp-to-drive-reverse voltage changes during the ramp-to-drive-reverse period.

12. The method of claim 1, further comprising applying one or more hold-reverse voltages to the electrochromic device after the hold period, wherein:
each hold-reverse voltage is applied for a hold-reverse period, and
the one or more hold-reverse voltages have a polarity that is opposite from the polarity of the hold voltage.

13. The method of claim 12, further comprising applying a hold-forward voltage to the electrochromic device for a hold-forward period after each hold-reverse voltage is applied, wherein the hold-forward voltage has same polarity as polarity of the hold voltage.

14. The method of claim 13, further comprising applying a ramp-to-hold-reverse voltage immediately before applying each hold-reverse voltage, wherein the ramp-to-hold-reverse voltage changes at a rate in a range of about 10 to about 250 mV/s until reaching the hold-reverse voltage.

15. The method of claim 14, wherein the ramp-to-hold-reverse voltage changes at a rate of about 50 mV/s until reaching the hold-reverse voltage.

16. The method of claim 13, further comprising applying a ramp-to-hold-forward voltage after applying a hold-reverse voltage and before applying a hold-forward voltage, wherein the ramp-to-hold-forward voltage changes at a rate in a range of about 10 to about 250 mV/s until reaching the hold-forward voltage.

17. The method of claim 1, wherein the drive voltage does not exceed a burn-in voltage.

18. A method of controlling optical states of an electrochromic device, comprising:
applying a ramp-to-drive voltage to the electrochromic device in a ramp-to-drive period, wherein the ramp-to-drive voltage has a magnitude profile that increases in the ramp-to-drive period;
applying, after the ramp-to-drive period, a drive voltage to the electrochromic device in a drive period, wherein the drive voltage has a substantially constant magnitude and a polarity that is the same as a polarity of the of the ramp-to-drive voltage at end of the ramp-to-drive period;
applying, after the drive period, a drive-reverse voltage to the electrochromic device in a drive-reverse period, wherein the drive-reverse voltage has (a) a polarity that is opposite from the polarity of the drive voltage, (b) a magnitude of about 1400 to 1900 millivolts, and (c) a duration of about 30 to 300 seconds; and
applying a hold voltage to the electrochromic device in a hold period, wherein the hold voltage has a polarity that is the same as the polarity of the drive voltage, wherein the hold voltage has a magnitude smaller than the magnitude of the drive voltage, and wherein the ramp-to-drive period, the drive period, the drive-reverse period, and the hold period are sequential in time.

19. A method of controlling optical states of an electrochromic device, comprising:
applying a ramp-to-drive voltage to the electrochromic device in a ramp-to-drive period, wherein the ramp-to-drive voltage has a magnitude that increases in the ramp-to-drive period;
applying, after the ramp-to-drive period, a drive voltage to the electrochromic device in a drive period, wherein the drive voltage has a substantially constant magnitude and a polarity that is the same as a polarity of the of the ramp-to-drive voltage at end of the ramp-to-drive period;
applying, after the drive period, a hold voltage to the electrochromic device in a hold period, wherein the hold voltage has a polarity that is the same as the polarity of the drive voltage and has a magnitude smaller than the magnitude of the drive voltage; and
applying, after the hold period, one or more hold-reverse voltages to the electrochromic device, wherein the one or more hold-reverse voltages have a polarity that is opposite from the polarity of the hold voltage.

20. The method of claim 19, wherein the method is configured to cause the electrochromic device to have a higher optical density at start of the hold period than at start of the ramp-to-drive period.

21. The method of claim 19, wherein the drive voltage has a magnitude that is substantially the same as a magnitude of the ramp-to-drive voltage at end of the ramp-to-drive period.

22. The method of claim 19, wherein the ramp-to-drive voltage has a magnitude that increases in the ramp-to-drive period at a rate in a range of about 1 to 250 millivolts/second (mV/s).

23-42. (canceled)
